(19) United States
(12) Patent Application Publication
(10) Pub. No.: US 2002/0085499 A1
(43) Pub. Date: Jul. 4, 2002

(54) ATM communication monitoring device

(76) Inventors: Takeshi Toyoyama, Yokohama (JP); Masao Nakano, Yokohama (JP); Yasuhiro Ooba, Kawasaki (JP)

Correspondence Address: Rosenman & Colin LLP, 575 Madison Avenue, New York, NY, 10022-2585, US

(21) Appl. No.: 10/078,341

(22) Filed: Feb. 19, 2002

Related U.S. Application Data
(63) Continuation of application No. PCT/JP99/04482, filed on Aug. 20, 1999.

(51) Int. Cl. H04L 12/26

(52) U.S. Cl. 370/236.2; 370/395.1

(57) ABSTRACT

In an ATM communication monitoring device which monitors by using a monitor timer, a connection ID generator generates connection ID's, and an OAM cell generator queues connection information of an OAM cell to be generated corresponding to the connection ID's at a predetermined cycle where the fundamental cycle signal is counted and generates the OAM cell, in order to increase operation time accuracy of the monitor timer and reduce the hardware cost. Also, a counter counts the fundamental cycle signal, and an OAM cell generator queues connection information of an OAM cell corresponding to the connection ID's at a predetermined cycle based on a value of the counter and generates the OAM cell.

### BACKGROUND OF THE INVENTION

1. Field of the Invention

The present invention relates to an ATM communication monitoring device, and in particular to an ATM communication monitoring device which monitors with a monitor timer.

Recently, an ATM (Asynchronous Transfer Mode) communication system adopting a cell-based transfer mode is being made popular in many fields owing to a high adaptability to a variety of information such as voice, video, and data, and to an enhanced data transfer speed.

An ATM communication monitoring device which manages, controls, and monitors an operation of the ATM communication system to enhance its reliability is required. The ATM communication monitoring device has many monitoring functions requiring a monitor timer, so that accurately and economically realizing these functions is desired.

2. Description of the Related Art

An ATM communication monitoring device has an alarm transfer function for a fault detection, a fault recovery notification, a fault management cell generation, and the like; a continuity check function for always monitoring a continuity state of a VP/VC connection; a loopback function for confirming a continuity in a designated section of the VP/VC connection and for isolating a fault point without interrupting services; a start/stop function for starting/stopping the continuity check function or a performance monitoring function, and the like.

FIG. 23 shows an alarm transfer function example of an ATM layer. The VP/VC connection is set up between end point devices 60 and 64 through connecting point devices 61-63.

The connecting point device 62 detects a transmission line fault, the point being indicated with a symbol X, which has occurred between the device 62 itself and the end point device 60, and cyclically transmits fault management cells (hereinafter, referred to as AIS (Alarm Indication Signal) cells) 71a, 71b, . . . to the end point device 64.

When receiving the AIS cells, the end point device 64 transitions to an alarm state (AIS state), and cyclically transmits fault management cells (hereafter, referred to as RDI (Remote Detect Indication) cell) 72a, 72b, 72c, . . . to the opposed device 60.

The transmission cycle of the AIS cell or the RDI cell is prescribed by the ITU-T standards committee. A device on the transmission side requires a monitor timer for clocking the transmission cycle.

Also, e.g. the end point device 64 or 60 having received the AIS cell or the RDI cell transitions to the alarm state (AIS or RDI state). As a condition for recovering from this alarm state, the ITU-T prescribes the case where the AIS cell or the RDI cell is not received for a fixed time period. Accordingly, the end point devices 64 and 60 require a monitor timer for determining that the AIS cell or the RDI cell is not received for a fixed time period.

FIG. 24 shows an example of a continuity check function.

In the absence of a user cell to be transmitted for a fixed time period after transmitting a user cell 70, the end point device 60 transmits a continuity check cell (CC cell) 73. The end point device 64 on the reception side confirms a connection by receiving any cell of the VP/VC connection such as a user cell 70 or a CC cell 73.

When receiving no cell of the VP/VC connection for a fixed time period, the end point device 64 transitions to the alarm state (the same as the AIS state), and cyclically transmits the RDI cells 72a, 72b, 72c, . . . to the opposed device 60.

Accordingly, the end point device 60 on the transmission side requires a monitor timer for transmitting the CC cell. The end point device 64 on the reception side requires a monitor timer for detecting a no-cell reception and a monitor timer for clocking a transmission cycle.

FIG. 25 shows an example of a loopback function.

The end point device or the connecting point device of the VP/VC connection (the connecting point device 62 in FIG. 25) inserts a loopback cell (LB cell) 74, so that a device designated as a loopback point (the end point device 64 in FIG. 25) sends back the received LB cell 74.

The connecting point device 62 on the transmission side receives the LB cell 74 within a fixed time period after transmitting the LB cell 74 to confirm the continuity of the VP/VC connection.

Accordingly, the connecting point device 62 requires a monitor timer for determining whether or not the LB cell is received within a fixed time period.

FIG. 26 shows an example of a start/stop function.

In the connection for performing the continuity check function or the performance monitoring function, e.g. the connecting point device 62 transmits a start/stop (request) cell 75 carrying a start/stop request message to the end point device 64.

When not receiving a start/stop response (confirmation or rejection) cell 76 carrying a response message (whether or not the start/stop is possible) within a fixed time period after transmitting the start/stop cell 75, the connecting point device 62 resends the start/stop (request) cell 75.

The end point device 64 receives the start/stop (request) cell 75, and waits for a response from a system manager (not shown) concerning the determination of whether or not the start/stop is possible. In the absence of the response within a fixed time period, the end point device 64 transmits a start/stop cell 76 carrying a message of a start/stop rejection.

Accordingly, the connecting point device 62 requires a monitor timer for determining whether or not the start/stop cell carrying the response message from the end point device 64 is received after transmitting the start/stop cell 75 to the end point device 64. The end point device 64 requires a monitor timer for waiting a response from the system manager for determining whether or not the start/stop is possible.

Hereinafter, the AIS cell, the RDI cell, the CC cell, the LB cell, the start/stop cell, and the like are occasionally represented by an OAM cell.

FIG. 27 shows a format example of the AIS/RDI cell.

The AIS/RDI cell is composed of a 5-byte header portion and a 48-byte payload portion. The header portion is composed of a GFC portion, a VPI portion, a VCI portion, a PTI portion, a CLP portion, and an HEC portion. The payload portion is composed of a 4-bit OAM type portion indicating a classification of an OAM cell, a 4-bit function-type portion indicating a classification of a function, a 1-byte fault classification code portion, a 16-byte fault location No. code portion, a 28-byte “6A (hex)”, a 6-bit “0”, and a 10-bit CRC-10 portion.

FIG. 28 shows an arrangement of an alarm state timer monitor 30.

A connection ID generator 20 includes a fundamental (basic) timer, and outputs a connection ID signal 102 and a sampling cycle signal 103 based on the output signal of the fundamental timer.

The alarm state timer monitor 30 is composed of an AND circuit 32 for outputting the sampling cycle signal 103 as a write enable signal 106 only when an alarm state signal 105 is “1”, an alarm state monitoring memory 31 for storing write data (counter value) 107 in an address designated by the connection ID signal 102 when the write enable signal 106 is “1”, an arithmetic unit (AU) 33 for outputting the write data 107 obtained by adding “1” to read data 108 from the memory 31, and a counter value determiner (determining portion) 34 for determining whether or not the read data (counter value) 108 corresponding to a connection ID have reached a predetermined threshold value.

Namely, the alarm state timer monitor 30 counts up each counter by “1” corresponding to the connection ID within the alarm state monitoring memory 31 when the alarm state signal 105 corresponding to the connection ID is “1”. When the value of each counter has reached a predetermined threshold value (held by the counter value determiner 34 or inputted from outside) respectively corresponding to the connection ID or a fixed threshold value, the counter value determiner 34 outputs an alarm recovery signal 109.

By this alarm recovery signal 109, the state of the point device which has transitioned to an alarm state by the AIS cell, for example, recovers from the alarm state to return to the normal state. Also, when the AIS cell is received before reaching the predetermined threshold value, the counter is cleared, so that the alarm state is kept without outputting the alarm recovery signal 109.

Namely, by the counter within the memory 31, a monitor timer (counter) for monitoring the alarm state corresponding to the connection ID is formed.

FIG. 29A shows an arrangement of the connection ID generator 20 shown in FIG. 28. This connection ID generator 20 is composed of a counter 11 for counting a cycle signal (not shown) and for outputting the connection ID signal 102, a maximum value decoder 13 for inputting the counter value of the counter 11, for detecting the preset maximum value, and for outputting a load signal 104 indicating a timing of loading data (e.g. “0”: not shown) to the counter 11, and a decoder 12 for outputting the sampling cycle signal 103 when the counter 11 indicates a specified counter value.

FIG. 29B shows a counter 11. The counter 11 is composed of an upper invalid range on an MSB side, a connection ID range indicating a connection ID, and a lower invalid range on an LSB side.

FIG. 29C shows a value of the counter 11 indicating the output timing of the sampling cycle signal 103. Namely, when the bits of the upper and the lower invalid ranges of the counter 11 are both “0”, the sampling cycle signal 103 assumes “1”, and otherwise assumes “0”.

Thus, when the counter 11 is counted up from “0” to the maximum decode value for example, the sampling cycle signal 103 outputs “1” at the timing of counting up the connection ID range by “1” every time the lower invalid range assumes “0” within a section where the upper invalid range of the counter value assumes “0”.

Namely, the sampling cycle signal 103 outputs “1” every time the connection ID signal 102 is sequentially designated.

FIG. 30 shows an arrangement of an OAM cell generator 40. This OAM cell generator 40 is composed of OAM cell generation timers 59_1-n (occasionally, represented by a reference numeral 59) corresponding to a plurality of lines 1-n, a line selector 48 for inputting cell inserting request signals 125_1-n (occasionally, represented by a reference numeral 125) which request a cell insertion respectively from the OAM cell generation timers 59_1-n, a cell assembler 46 for receiving the cell inserting request signal 125 selected by the line selector 48 and for assembling the cell, and a cell inserter 47 for determining whether or not a cell from the cell assembler 46 can be inserted into an output cell flow 126, for outputting the cell as an outputting cell 127 when the insertion is possible, and for providing line cell insertion disable signals 130_1-n (occasionally, represented by a reference numeral 130) to the OAM cell generation timers 59_1-n when the insertion is impossible.

Each OAM cell generation timer 59 is composed of a connection ID generator 49 for a cell generation which inputs the line cell insertion disable signal 130 from the cell inserter 47 to an enable terminal and which outputs the connection ID signal 102 and the sampling cycle signal 103, a cell generation cycle memory 41 which inputs the connection ID signal 102 and the sampling cycle signal 103 respectively to an address terminal and a write enable terminal, which stores the write data 107 and outputs the data as the read data (counter value) 108, an arithmetic (operating) unit 42 which outputs the write data 107 obtained by adding “1” to the read data 108, a counter value determiner 43 which determines whether or not the read data 108 has reached a predetermined value per each connection ID and outputs a cell generation cycle arrival signal 123, and an AND circuit 44 which inputs the arrival signal 123, the sampling cycle signal 103, and a fault state signal 124, and outputs the cell inserting request signal 125.

Namely, in the same way as the arrangement of the alarm state monitor timer comprising the memory 31, the AND circuit 32, the arithmetic unit 33, and the counter value determiner 34 of the alarm state timer monitor 30 shown in FIG. 28, the monitor timer for the cell generation cycle corresponding to each connection ID comprises the cell generation cycle memory 41, the arithmetic unit 42, and the counter value determiner 43. It is to be noted that the description of the operation by which each counter of the cell generation cycle memory 41 is cleared will be omitted.

FIG. 31A shows an arrangement of the connection ID generator 49 for the cell generation shown in FIG. 30.

This connection ID generator 49 is different from the connection ID generator 20 for the alarm state monitor shown in FIG. 29 in that the cell insertion disable signal 130 is provided to the enable terminal of the counter 11. With this cell insertion disable signal 130, the counter 11 stops the counter operation.

FIG. 31B shows ranges included in the counter 11. FIG. 31C shows a timing of an output of the sampling cycle signal 103. These are the same as FIGS. 29B and 29C.

FIG. 32 shows an arrangement of the cell generation cycle memory 41 shown in FIG. 30.

In this cell generation cycle memory 41, areas for addresses “0”-“n” designated by the connection ID's=“0”-“n” are set for storing a counter value per each connection.

FIGS. 33A-E show operation examples of the counter (monitor timer) of the connection ID=“1” in the cell generation cycle memory 41.

In FIG. 33B, the connection ID's=“0”, “1”, “2”, are sequentially and repeatedly inputted to the address terminal of the cell generation cycle memory 41 (FIG. 33B).

When the connection ID=“1” is accessed before a monitor start instructing signal (omitted in FIG. 30) is produced (FIGS. 33A(a) and 33B(a)), an access classification to the memory 41 is R (Read) (FIG. 33C(a)), its read data 108=“0” (FIG. 33D(a)), and its write data=“1” (FIG. 33E(a)).

When the monitor is started, the counter value corresponding to the connection ID=“1” within the memory 41 is cleared.

When the connection ID=“1” is accessed after the monitor start instructing signal is produced, the access classification to the memory 41 is Read after Write (RW) (FIG. 33C(b)), and its read data=“0” (FIG. 33D(b)). Its write data=“1” (FIG. 33E(b)) is written, so that the contents of the counter assume “1”.

When the next connection ID=“1” is accessed, the read data=“1” (FIG. 33D(c)). The write data=“2” (FIG. 33E(c)) is written, so that the contents of the counter assume “2”.

Hereafter, the counter is incremented by “1” every time the access is made by the address of the connection ID=“1” in the same manner.

FIG. 34 shows an operation example of the line selector 48, the cell assembler 46, and the cell inserter 47 in the OAM cell generator 40 shown in FIG. 30.

At step S10, the line selector 48 checks whether or not the cell inserting request signal 125 of an insertion priority line 1 for example indicates a cell inserting request. If it indicates the cell inserting request, the cell inserter 47 checks whether or not it is possible to insert the cell into the output cell flow 126 (at step S11). When the cell insertion is possible, the fact is notified to the cell assembler 46. The cell assembler 46 assembles the cell of the corresponding connection ID to be provided to the cell inserter 47.

FIG. 35 shows an arrangement of the cell assembler 46. This cell assembler 46 includes selection circuits 46_1-46_3. The selection circuit 46_1 inputs “OAM for the AIS cell+function-type (classification)”, “OAM for the RDI cell+function-type”, . . . indicating the OAM cell classification and the function-type, and a selection signal (not shown) instructing to select one of them, and outputs the selected “OAM type of a generating cell+function type”.

The selection circuit 46_2 inputs “fault classification code 1”, “fault classification code 2”, . . . indicating the fault classification, and a selection signal (not shown) instructing to select one of them, and outputs the selected “fault classification code of a generating cell”.

The selection circuit 46_3 inputs “fault location No. 1”, “fault location No. 2”, . . . indicating a location where a fault has occurred, and a selection signal (not shown) instructing to select one of them, and outputs the selected “fault location No. of a generating cell”.

The output signals “OAM type of a generating cell+function type”, “fault classification code”, and “fault location No. of a generating cell” selected by the selection circuits 46_1-3 are respectively inserted into the 0th byte, the 1st byte, the 2nd-17th bytes of the payload portion of the OAM cell shown in FIG. 27.

The cell inserter 47 sets the concerned line cell insertion disable signal 130_1 to “0” indicating that the cell insertion is possible (at step S13), and executes the cell insertion without stopping the counter 11 (at step S14).

When the cell inserting request is not indicated at step S10, the insertion priority line is made the insertion priority line+1, so that the process returns to step S10 with the insertion priority line=line 2.

Hereafter, until the line indicating the cell inserting request appears, the same process is repeated.

When the insertion is not possible at step S11, the cell inserter 47 sets the line cell insertion disable signal 130 to “1” indicating the insertion impossible (at step S15), stops the counter 11 of the line 1, and makes the insertion priority line=the insertion priority line+1, so that the process returns to step S10 with the insertion priority line=line 2.

Hereafter, the line selector 48 sequentially selects line 2-line “n” as an insertion priority line in the same manner, so that the cell assembler 46 and cell inserter 47 respectively assemble and insert the OAM cell of the corresponding connection cell.

FIGS. 36A-36E show generation timing examples of an OAM cell in the OAM cell generator 40 shown in FIG. 30.

FIG. 36A shows a connection ID signal 102. This signal 102 is the same as that in FIG. 33B. However, FIG. 36A shows a case where the sampling cycle signal 103 is e.g. 250 ms, where only the connection ID's “0”-“3” generated in a cycle of 1 second (250 ms×4) are indicated and the other connection ID's “4”, are omitted.

When the first connection ID signal 102=“0”-“3”, the counter value corresponding to each connection ID is assumed to be “0”. The counter (monitor timer) corresponding to the connection ID=“0”-“3” is sequentially incremented per sampling cycle signal, so that 1 second is assumed to elapse every counter value=“3”.

Determining that the read data (counter value) 108 corresponding to the connection ID=“0” has reached a predetermined threshold value=“3”, the counter value determiner 43 outputs the cell generation cycle arrival signal 123. When the cell generation cycle arrival signal 123, the sampling cycle signal 103, and the fault state signal 124 are all “1”, the AND circuit 44 transmits the cell inserting request signal 125 to the cell assembler 46 through the line selector 48.

The cell assembler 46 assembles the OAM cell corresponding to the connection ID, and requests the cell inserter 47 to insert the OAM cell. The cell inserter 47 inserts the OAM cell of the connection ID=“0” (FIG. 36A).

Similarly, when the monitor timer corresponding to the connection ID=“1” indicates that a predetermined time, e.g. 1 second has elapsed, and the OAM cell insertion of the connection ID=“1” is requested to the cell inserter 47 but it can not be inserted, the cell inserter 47 transmits the line cell insertion disable signal 130 indicating the line insertion impossible to the counter 11 (see FIG. 31A), and stops the counter 11.

By the stop of the counter 11, the monitor timer corresponding to each connection ID is stopped.

In α seconds, the cell inserter 47 succeeds in the OAM cell insertion of the connection ID=“1” (1st counter stop timing in FIG. 36C). Hereafter, the cell inserter 47 transmits the line cell insertion disable signal 130_1 indicating the line insertion possible to the counter 11 within the connection ID generator 49 to start the counter 11.

Hereafter, when the monitor timer of the connection ID=“2” indicates that a predetermined time, e.g. 1 second has elapsed, the cell inserter 47 succeeds in the insertion of the OAM cell in the same manner (FIG. 36D). Then, the monitor timer of the connection ID=“3” indicates that a predetermined time, e.g. 1 second has elapsed, the cell inserter 47 does not succeed in the insertion of the OAM cell, transmits the line cell insertion disable signal 130_1 to stop the counter 11, and succeeds in the insertion after α seconds (2nd counter stop timing of FIG. 36E).

As a result, an insertion delay in the OAM cell of the connection ID=“3” assumes at least 2 α seconds where the insertion delay (α seconds) of the OAM cell of the connection ID=“1” is also added, so that the insertion time of the following OAM cells of all the connection ID's is further delayed by 2α seconds compared with a predetermined insertion cycle. Namely, the insertion delays which have occurred at the OAM cells of the connection ID's are all added, and are added as an insertion delay time of all the following OAM cells.

In such a prior art ATM communication monitoring device, the number of user cells flowing during the processing becomes large as the number of processing connections becomes large in the OAM cell generating processing, so that there have been problems as follows: Unsuccess probability of the OAM cell insertion becomes high, the difference of the cell generation cycle becomes large, the counter for generating the connection ID is stopped, and the difference of the OAM cell generation cycle is accumulated with the counter stop.

Also, since the counter operation of the connection ID generator for the alarm state monitor and that for the OAM cell generation are different from each other, they can not be shared and provided individually, so that there has been a problem that a hardware cost is increased.

### SUMMARY OF THE INVENTION

It is accordingly an object of the present invention to provide an ATM communication monitoring device which monitors by using a monitor timer, wherein accuracy of operation time of the monitor timer is enhanced and the hardware cost is reduced.

(1) In order to achieve the above-mentioned object, an ATM communication monitoring device according to the present invention comprises: a fundamental timer for producing a fundamental cycle signal; a connection ID generator for generating connection ID's equal to or more than one within a section of the fundamental cycle signal; and an OAM cell generator for queuing connection information of an OAM cell to be generated corresponding to the connection ID's at a predetermined cycle where the fundamental cycle signal is counted per each connection ID and for generating the OAM cell.

Namely, a connection ID generator sequentially generates connection ID's equal to more than one between the fundamental cycle signals. An OAM cell generator counts the fundamental cycle signal per each connection ID, determines whether or not the counter value has reached a predetermined value. When it has reached the predetermined value, the OAM cell generator queues connection information of the OAM cell corresponding to the connection ID and sequentially outputs the OAM cell to an output cell flow based on the connection information.

FIG. 1A shows a cell generation timing of the OAM cell generator. The connection ID generator sequentially outputs the connection ID such as “0”, “1”, “2”, “3”, . . . within 1 cycle of the fundamental cycle signal. The OAM cell generator queues the connection information of the connection ID necessary to generate the OAM cell e.g. in a cycle of 1 second where 4 fundamental cycle signals produced per 250 ms are counted.

The OAM cell generator takes out the queued connection information, and sequentially outputs the OAM cell to the output cell flow of the connection corresponding to the connection information.

Namely, as shown in FIG. 1B, e.g. the 2nd OAM cells of the connection ID's=“0” and “2” are respectively outputted after 1 second from the 1st OAM cell output points. Supposing that there is no empty space when the 2nd OAM cells of the connection ID's=“1” and “3” are outputted, they are respectively outputted with α and β seconds being delayed. However, these delays have no influence on the 3rd and the following output timings (not shown) of the OAM cells of the connection ID's=“1” and “3” and the following output timings of the connection ID's=“0” and “2”.

Namely, the OAM cell generator queues to insert the OAM cell to be outputted into the output cell flow until the insertion becomes possible, and does not stop the count corresponding to the connection ID of the fundamental cycle signal. Accordingly, the counter operation is not influenced by the OAM cell output operation, and there is no accumulation of the queuing time for the cell insertion, thereby enhancing the accuracy of the monitor timer.

(2) Also, in the ATM communication monitoring device according to the present invention, the OAM cell generator may have a cell generation cycle memory for counting the fundamental cycle signal per each connection ID.

Namely, a counter corresponding to each connection ID is set within the cell generation cycle memory, and each counter may count the fundamental cycle signal.

(3) Also, in the ATM communication monitoring device according to the present invention, the connection ID generator may further generate a monitoring control signal indicating that the connection ID is valid, and the memory may count the fundamental cycle signal based on the monitoring control signal.

Namely, the connection ID generator generates a monitoring control signal indicating that a generated connection ID is valid, and adds 1 to the counter of the valid connection ID within the memory when the monitoring control signal indicates valid. Thus, the connection ID generator can perform the same operation as the monitor timer operation of counting the fundamental cycle signal.

(4) Also, an ATM communication monitoring device according to the present invention comprises: a fundamental timer for producing a fundamental cycle signal; a connection ID generator for generating connection ID's equal to or more than one within a section of the fundamental cycle signal; a counter for counting the fundamental cycle signal; and an OAM cell generator for queuing connection information of an OAM cell to be generated corresponding to the connection ID's at a predetermined cycle based on a value of the counter and for generating the OAM cell.

Namely, in the ATM communication monitoring device according to the present invention, the OAM cell generator does not count the fundamental cycle signal per each connection ID as in the ATM communication monitoring device of the above-mentioned present invention (1) but determines a timing of a predetermined cycle when the OAM cell is generated by the counter value, queues the connection information of the OAM cell corresponding to each connection ID, and sequentially outputs the OAM cell to the output cell flow based on the connection information.

Thus, the preparation of the counter per each connection ID becomes unnecessary, thereby enabling the hardware cost to be reduced.

(5) Also, in the ATM communication monitoring device of the present invention according to the above-mentioned present invention (4), timings for queuing the OAM cell may be dispersed based on the counter value.

Namely, the dispersion of the cell generation timing to each counter value enables success probability of a cell insertion to be increased.

(6) Also, the ATM communication monitoring device according to the present invention in the above-mentioned present invention (1) or (4) may further comprise an alarm state timer monitor for counting the fundamental cycle signal per each connection ID and for monitoring whether or not a monitor state of each connection ID is held for a predetermined time.

Namely, when the connection of the connection ID is in an alarm state such as an AIS/RDI alarm state or an LOC state, or in a monitor state of an NG occurrence such as for a loopback monitor and a start/stop response monitor, an alarm state timer monitor counts the fundamental cycle signal to monitor the duration of state to be monitored in the concerned connection.

Thus, it becomes possible to share the fundamental timer and the connection ID generator for the alarm state monitor with the fundamental timer and the connection ID generator for the OAM cell generation, thereby reducing the hardware cost.

(7) Also, in the ATM communication monitoring device according to the present invention, the alarm state timer monitor may have an alarm state monitoring memory for counting the fundamental cycle signal per each connection ID.

Namely, in the same way as the OAM cell generator in the above-mentioned present invention (2), the alarm state timer monitor may set a counter corresponding to each connection ID within the cell generation cycle memory, and the counter may count the fundamental cycle signal.

(8) Also, in the ATM communication monitoring device according to the present invention, the connection ID generator may further generate a monitoring control signal indicating that the connection ID is valid, and the alarm state monitoring memory may count the fundamental cycle signal based on the monitoring control signal.

Namely, in the same way as the above-mentioned present invention (3), the connection ID generator generates the monitoring control signal indicating that the generated connection ID is valid, and adds 1 to the counter corresponding to the valid connection ID in the alarm state monitoring memory when the monitoring control signal indicates validness, thereby enabling the monitor timer operation to be performed.

(9) Also, in the ATM communication monitoring device of the present invention according to the above-mentioned present invention (1) or (4), the OAM cell generator may comprise a cell generation information queue portion for queuing the connection information, a cell assembler for assembling an OAM cell based on the queued connection information, and a cell inserter for determining whether or not a cell insertion is possible and for inserting the assembled OAM cell into an output cell flow.

Namely, a cell generation information queue portion sequentially stores the connection information as a queue. A cell assembler takes out the first stored connection information, and assembles the OAM cell based on the information. A cell inserter inserts the OAM cell into the cell output flow when there is an empty space in the cell output flow.

Hereafter, the connection information is taken out in a stored order from the cell generation information queue portion, so that the corresponding OAM is assembled to be inserted into the cell output flow in the same manner.

(10) Also, in the ATM communication monitoring device according to the present invention, the connection ID generator may include a counter for generating the connection ID for a plurality of lines.

Namely, the connection ID generator prepares a counter for counting the total number of the connection ID's included in the lines, so that the connection ID's of a plurality of lines are associated with the counter values.

Thus, the fundamental timer and the connection ID generator for a plurality of lines can be shared, thereby enabling the hardware cost to be reduced.

(11) Also, in the ATM communication monitoring device according to the present invention, the connection information may comprise at least connection ID information, generated OAM cell classification information, and fault classification information, as well as line ID information for a plurality of lines.

Namely; the OAM cell generator queues only connection ID information, OAM cell classification information, and fault classification information as the minimum connection information required for assembling the OAM cell of the connection to be generated, and further queues line ID information for a plurality of lines.

Thus, it becomes unnecessary to queue all of the information of the OAM cell corresponding to the connection ID, and a required memory capacity is reduced, thereby enabling the hardware cost to be reduced.

(12) Also, in the ATM communication monitoring device according to the present invention, the OAM cell classification information, the fault classification information, and the line ID information may be coded.

Namely, it is possible to reduce the required memory capacity for queuing each information by coding.

(13) Also, the ATM communication monitoring device according to the present invention in the above-mentioned present invention (1) or (4) may further comprise: a counter for counting the fundamental cycle signal; an alarm state monitoring memory for storing the counter value with a timer monitor start signal; a subtracter for computing a difference between a present counter value and the stored counter value; and a counter value determiner for comparing the difference with a predetermined monitored counter value and for determining whether or not a monitor state is held for a predetermined time.

Namely, instead of the alarm state timer monitor of the present invention (6), the counter is provided for counting the fundamental cycle signal in order to monitor the duration of a monitor state, and the alarm state monitoring memory stores the counter value with the timing of the timer monitor start signal. The subtracter computes the difference between the stored counter value and the present counter value. The counter value determiner compares the difference with a predetermined monitored counter value to determine whether or not a monitor state is held for a predetermined time.

Thus, it becomes possible to reduce a write access frequency to the alarm state monitoring memory, thereby decreasing power consumption of the memory and increasing its longevity.

Also, when the memory holding the counter value corresponding to a plurality of connection ID's is shared, less competition of an access occurs.

Also, in the same way as the above-mentioned present invention (6), the fundamental timer and the connection ID generator can be shared with those for the OAM cell generation. Furthermore, the counter can be shared with that of the above-mentioned present invention (4), thereby enabling the hardware cost to be reduced.

(14) Also, the ATM communication monitoring device according to the present invention in the above-mentioned present invention (1) or (4) may further comprise: a counter for counting the fundamental cycle signal; an adder for adding the counter value to a predetermined monitored counter value; an alarm state monitoring memory for storing an arithmetic result of the adder with a timer monitor start signal; and a counter value determiner for comparing the stored counter value with a present counter value and for determining whether or not a monitor state is held for a predetermined time.

Namely, instead of the alarm state timer monitor of the present invention (6), the counter for counting the fundamental cycle signal is provided in order to monitor the duration of the monitor state, and the adder adds the counter value and a predetermined monitored counter value to compute the counter value after the monitor state is held for a predetermined time. The monitor state monitoring memory stores the arithmetic result at the timing of the timer monitor start signal. The counter value determiner compares the stored counter value with the present counter value to determine whether or not the monitor state is held for a predetermined time.

Thus, in the same way as the above-mentioned present invention (13), consumption power of the alarm state monitoring memory can be reduced and its longevity is increased.

Also, in the same way as the above-mentioned present invention (14), the fundamental timer, the connection ID generator, and the counter can be shared with those in the OAM cell generator, so that the hardware cost can be reduced and an access competition to the common memory becomes hard to occur.

(15) Also, in the ATM communication monitoring device according to the present invention, the alarm state timer monitor may include a monitoring memory access controller for selecting by time-sharing an access to the alarm state monitoring memory based on a processing result from a processor of a receiving cell or an access to the alarm state monitoring memory by a timer monitor processing of the alarm state timer monitor.

Namely, a monitoring memory access controller selects a signal by which a processor of a receiving cell accesses the alarm state monitoring memory based on the processing result, and a signal accessing the alarm state monitoring memory by an alarm state monitoring timer processing at slots of time-shared different timings to allow the accesses.

Thus, by time-sharing a cell slot, for example, it becomes possible to alternately perform the alarm state monitoring memory access by the receiving cell processing result and that by a timer monitor processing, thereby enabling the access competition, which occurs at random, to the alarm state monitoring memory to be avoided.

(16) Also, the ATM communication monitoring device according to the present invention may further comprise a schedule manager for managing, by time-sharing, timings for an alarm monitor processing in the alarm state timer monitor and for an OAM cell generation processing in the OAM cell generator.

Namely, a schedule manager manages by time-sharing the timings for an alarm monitor processing in the alarm state timer monitor and for an OAM cell generation processing in the OAM cell generator.

Thus, if a schedule management is performed so that the OAM cell generation processing is performed after the alarm monitor processing, the time until the OAM cell generation after the alarm state detection, the time until the OAM generation stop after the fault recovery, and the like can be made as short as possible.

(17) Also, in the ATM communication monitoring device according to the present invention, the connection ID generator may comprise a connection ID counter for counting a cell slot signal and a flag storage for outputting the monitoring control signal indicating a period when a counter value of the connection ID counter is valid.

Namely, a connection ID counter outputs a value of counting a cell slot signal as a connection ID, and a flag storage stores a flag that the counter value indicates a valid period as a connection ID to be outputted.

Thus, it becomes possible to output the connection ID synchronized with the cell slot signal and becomes easy to synchronize with the OAM cell generator which outputs in synchronization with the cell slot signal.

(18) Furthermore, in the ATM communication monitoring device according to the present invention, the connection ID generator may comprise a processing frequency determiner for generating the connection ID by “n” cycles where “n” is a natural number and for outputting its cycle frequency signal, and the alarm state timer monitor and the OAM cell generator respectively time-share the alarm monitor processing and the OAM cell generation processing corresponding to the cycle frequency signal.

Namely, a processing frequency determiner determines that a generated connection ID makes e.g. 3 cycles to sequentially output cycle frequency signals “1”-“3”. The alarm state monitor and the OAM cell generator respectively perform the alarm monitor processing and the OAM cell generation processing with the time-shared timing at the cycle frequency signals “1”-“3”.

Thus, it becomes possible to disperse the processings and to set the order of the processings to an efficient order. When a plurality of OAM cells are required to be generated for a single connection, for example, the amount of queued information can be reduced, the hardware can be reduced, and the success probability of the OAM cell insertion can be increased by dispersing the insertion location of the OAM cell.

### BRIEF DESCRIPTION OF THE DRAWINGS

FIGS. 1A and 1B are time charts showing an operation principle of an OAM cell (example of generation cycle difference) in an ATM communication monitoring device according to the present invention;

FIG. 2 is a block diagram showing an embodiment (1) of an ATM communication monitoring device according to the present invention;

FIG. 3 is a block diagram showing an embodiment of a fundamental timer in an ATM communication monitoring device according to the present invention;

FIG. 4 is a diagram showing an arrangement of a connection ID counter in an ATM communication monitoring device according to the present invention;

FIG. 5 is a block diagram showing an embodiment (1) of an alarm state timer monitor in an ATM communication monitoring device according to the present invention;

FIG. 6 is a block diagram showing an embodiment (2) of an alarm state timer monitor in an ATM communication monitoring device according to the present invention;

FIG. 7 is a diagram showing an embodiment of a cell generation information queue portion in an ATM communication monitoring device according to the present invention;

FIG. 8 is a block diagram showing an embodiment of a cell assembler in an ATM communication monitoring device according to the present invention;

FIG. 9 is a block diagram showing an embodiment (2) of an ATM communication monitoring device according to the present invention;

FIGS. 10A-10D are time charts showing an operation example of an OAM cell generator in an ATM communication monitoring device according to the present invention;

FIG. 11 is a block diagram showing a modification (1) of an alarm state timer monitor in an ATM communication monitoring device according to the present invention;

FIG. 12 is a block diagram showing a modification (2) of an alarm state timer monitor in an ATM communication monitoring device according to the present invention;

FIG. 13 is a block diagram showing a modification (3) of an alarm state timer monitor in an ATM communication monitoring device according to the present invention;

FIG. 14 is a block diagram showing an embodiment (1) of a connection ID generator in an ATM communication monitoring device according to the present invention;

FIGS. 15A-15E are time charts showing an operation of an embodiment (1) of a connection ID generator in an ATM communication monitoring device according to the present invention;

FIGS. 16A-16H are time charts showing an operation of a modification (3) of an alarm state timer monitor in an ATM communication monitoring device according to the present invention;

FIG. 17 is a block diagram showing an embodiment (3) of an ATM communication monitoring device according to the present invention;

FIGS. 18A-18H are time charts showing an operation of an embodiment (3) of an ATM communication monitoring device according to the present invention;

FIG. 19 is a block diagram showing an embodiment (4) of an ATM communication monitoring device according to the present invention;

FIG. 20 is a block diagram showing an embodiment (5) of an ATM communication monitoring device according to the present invention;

FIG. 21 is a block diagram showing an embodiment (2) of a connection ID generator in an ATM communication monitoring device according to the present invention;

FIGS. 22A-22G are time charts showing an operation of an embodiment (5) of an ATM communication monitoring device according to the present invention;

FIG. 23 is a diagram illustrating an alarm transfer function in a general ATM communication monitoring device;

FIG. 24 is a diagram illustrating a continuity check function in a general ATM communication monitoring device;

FIG. 25 is a diagram illustrating a loopback function in a general ATM communication monitoring device;

FIG. 26 is a diagram illustrating a start/stop function in a general ATM communication monitoring device;

FIG. 27 is a diagram showing a format of an AIS/RDI cell in a general ATM communication monitoring device;

FIG. 28 is a block diagram showing an arrangement of an alarm state timer monitor in a prior art ATM communication monitoring device;

FIGS. 29A-29C are block diagrams showing an arrangement of a connection ID generator (-cum-fundamental timer) for alarm state monitor in a prior art ATM communication monitoring device;

FIG. 30 is a block diagram showing an arrangement of an OAM cell generator in a prior art ATM communication monitoring device;

FIGS. 31A-31C are block diagrams showing an arrangement of a connection ID generator (-cum-fundamental timer) for a cell generation in a prior art ATM communication monitoring device;

FIG. 32 is a block diagram showing an arrangement of a cell generation cycle memory in a prior art ATM communication monitoring device;

FIGS. 33A-33E are time charts showing an operation example of a cell generation cycle memory in a prior art ATM communication monitoring device;

FIG. 34 is a flow chart showing an operation example of an OAM cell generator in a prior art ATM communication monitoring device;

FIG. 35 is a block diagram showing an arrangement of a cell assembler in a prior art ATM communication monitoring device; and

FIGS. 36A-36E are time charts showing an operation example of a connection ID generator for an OAM cell generation in a prior art ATM communication monitoring device.

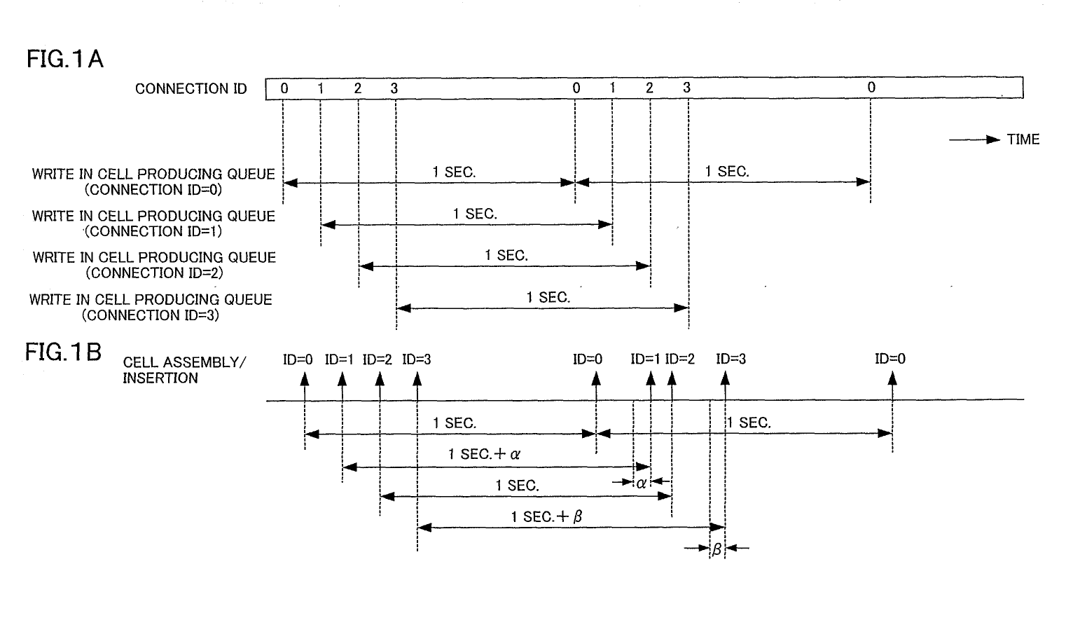

Throughout the figures, like reference numerals indicate like or corresponding components.

### DESCRIPTION OF THE EMBODIMENTS

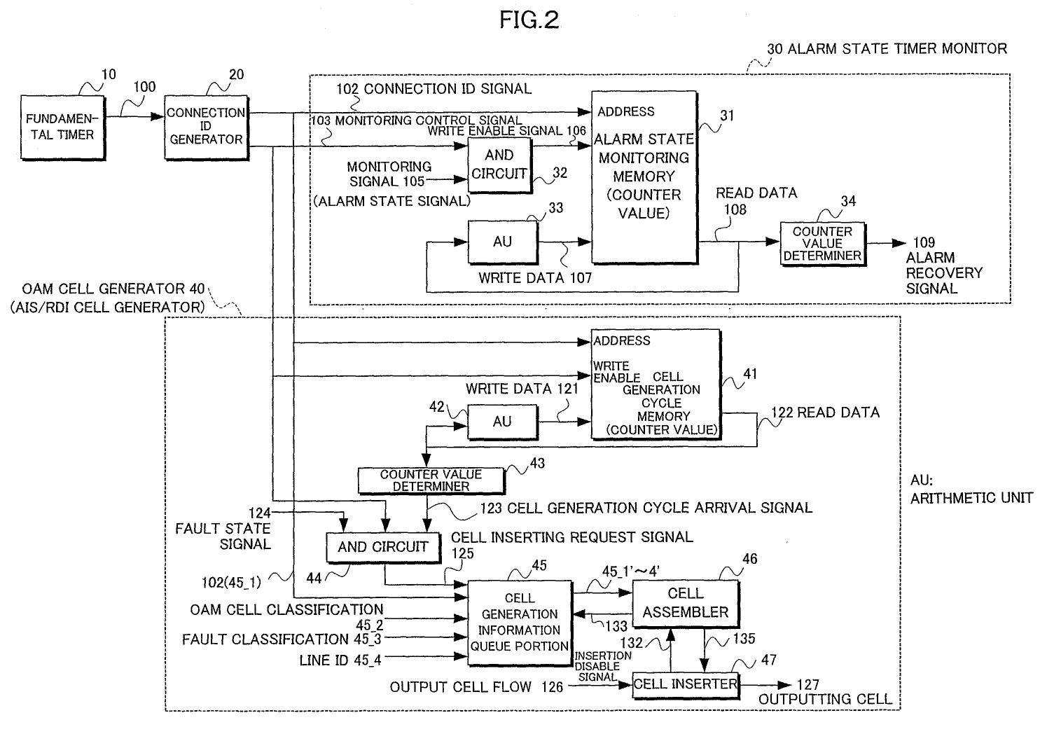

FIG. 2 shows an embodiment (1) of an ATM communication monitoring device according to the present invention.

This ATM communication monitoring device is composed of a fundamental timer 10, a connection ID generator 20 for receiving a fundamental cycle signal 100 from the fundamental timer 10, an alarm state timer monitor 30 and an OAM cell generator 40 for respectively receiving a connection ID signal 102 and a monitoring control signal 103 from the ID generator 20.

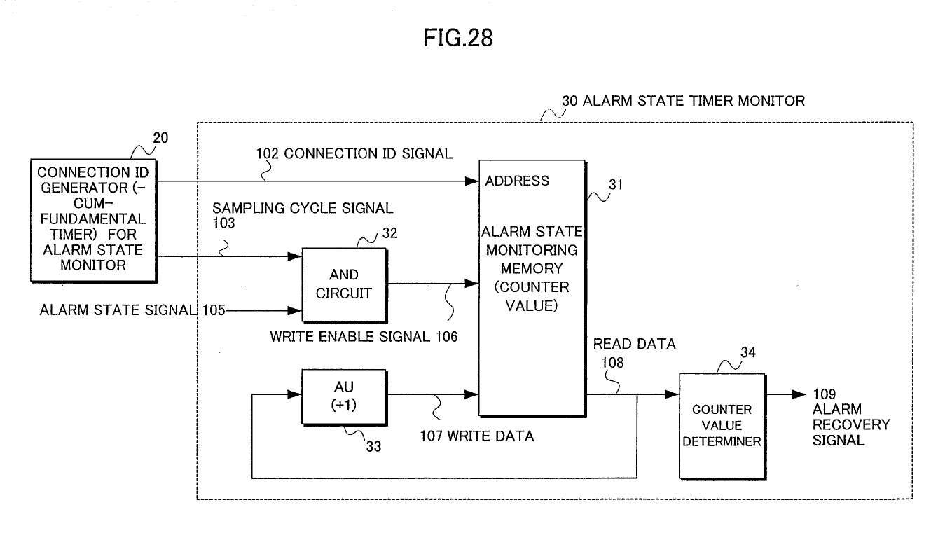

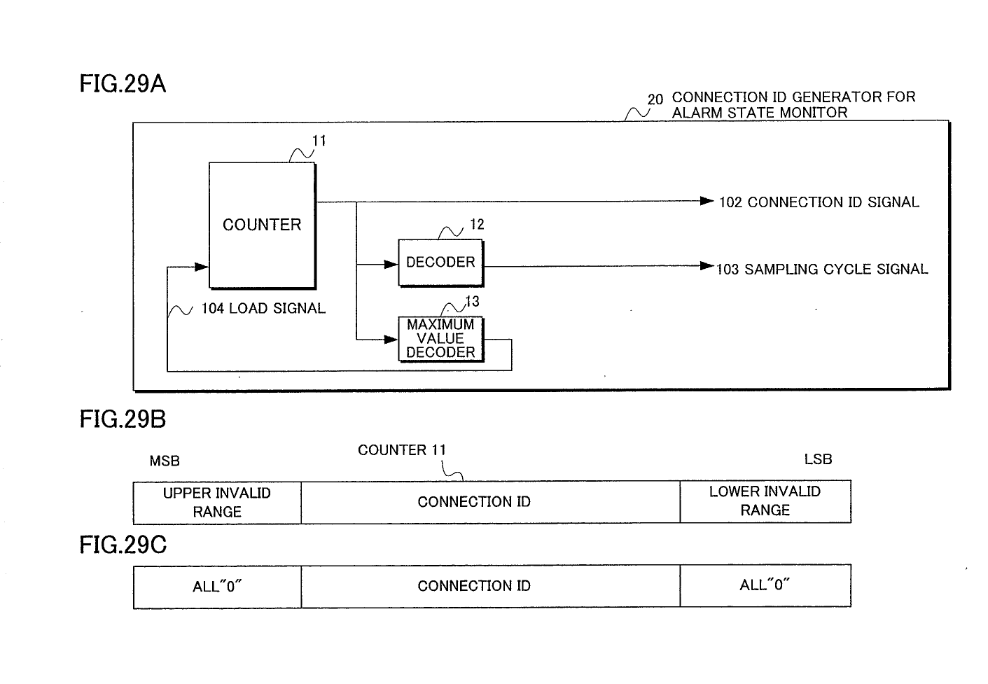

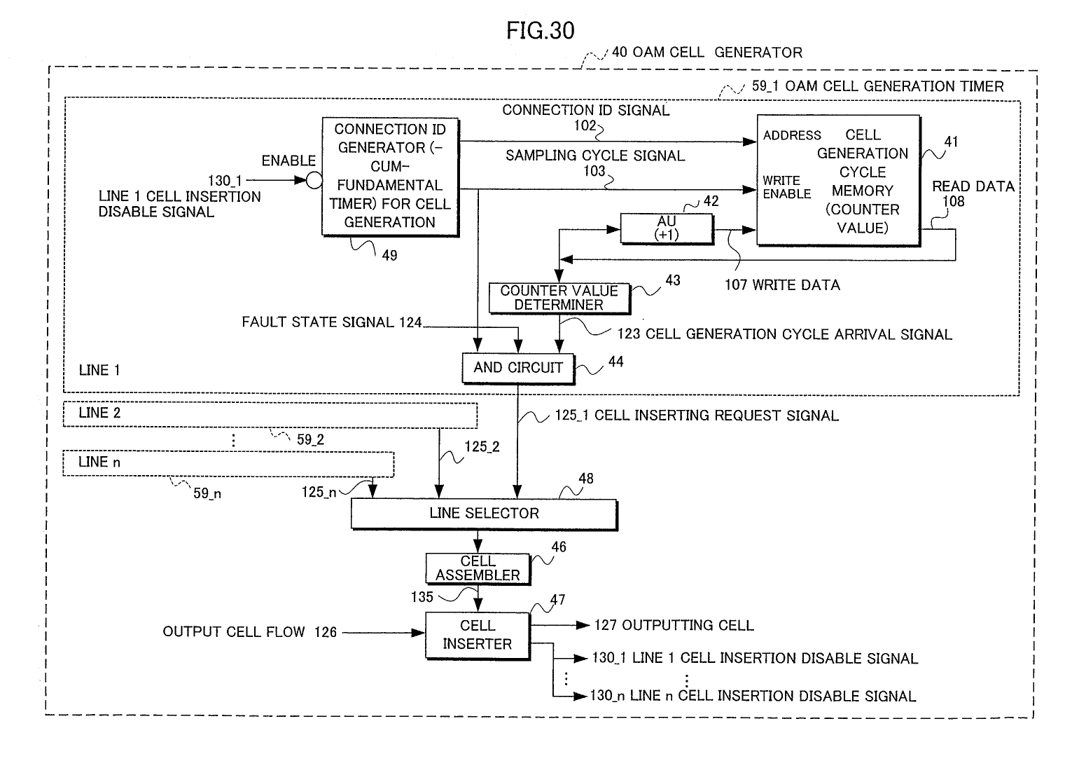

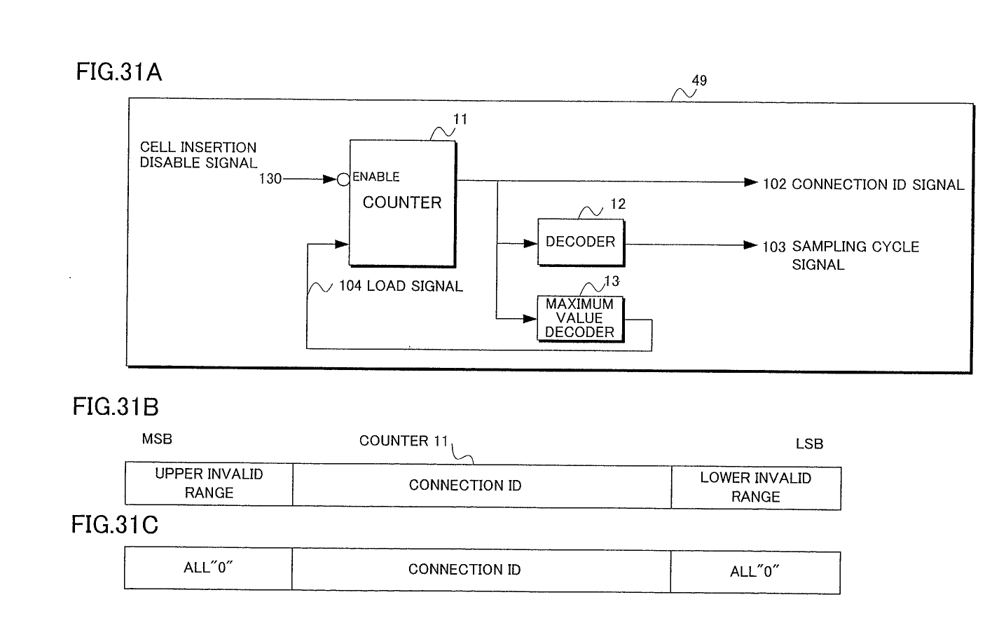

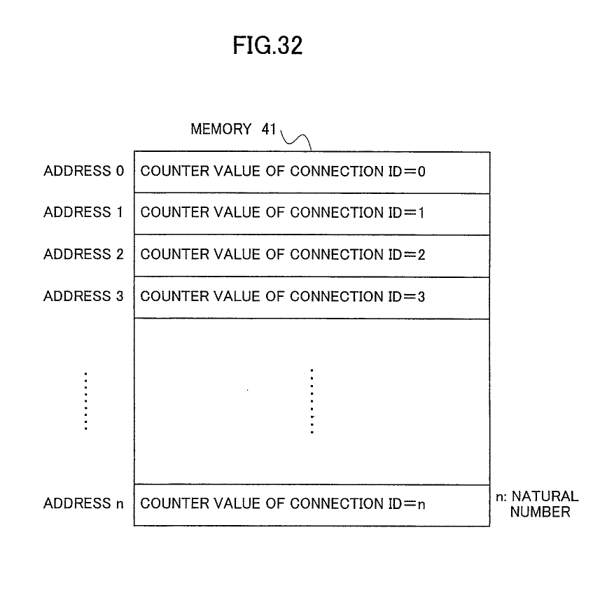

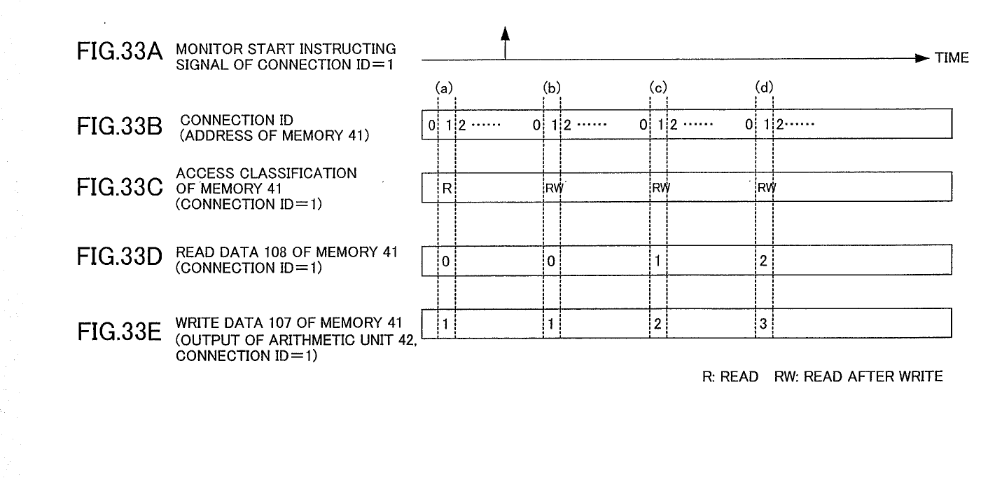

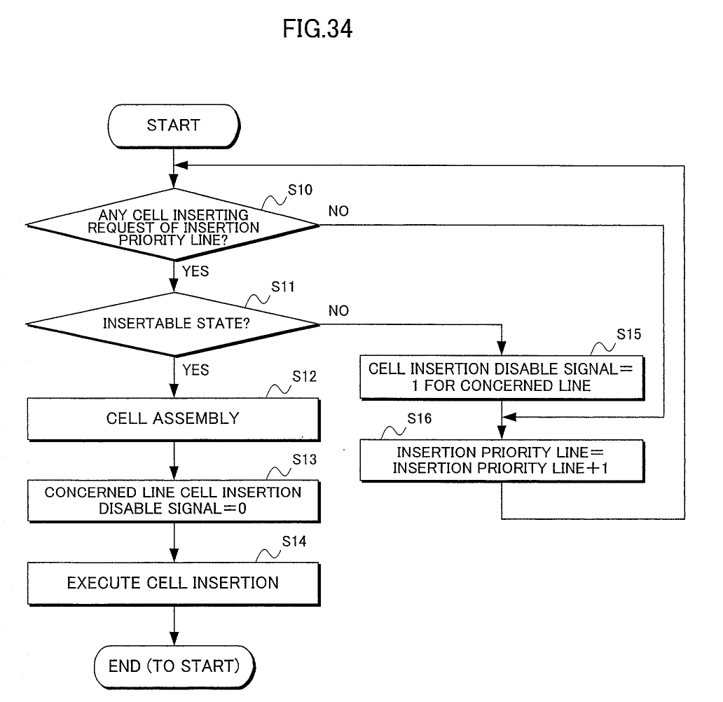

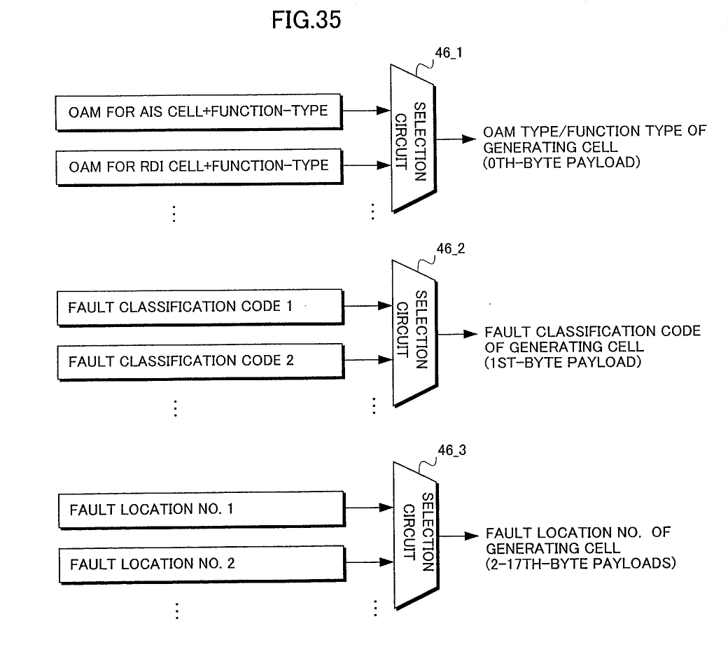

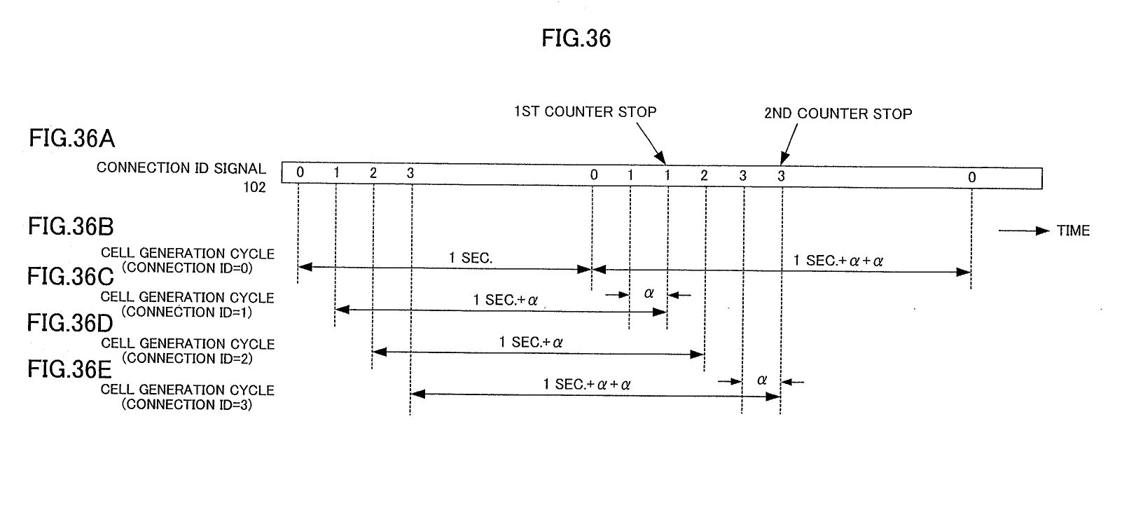

The arrangement of the alarm state timer monitor 30 is the same as that of the prior art alarm state timer monitor 30 shown in FIG. 28. However, in this embodiment, the sampling cycle signal 103 in FIG. 28 is referred to as the monitoring control signal 103.

The OAM cell generator 40 includes a cell generation cycle memory 41, an arithmetic unit (AU) 42, and a counter value determiner 43 respectively corresponding to a memory 31, an arithmetic unit 33, and a counter value determiner 34 except an AND circuit 32 in the alarm state timer monitor 30.

The connection ID signal 102 and the monitoring control signal 103 are respectively inputted to an address terminal and a write enable terminal of the memory 41. The monitoring control signal 103, write data 121, read data 122, and a cell generation cycle arrival signal 123 correspond to a write enable signal 106, write data 107, read data 108, and an alarm recovery signal 109.

The OAM cell generator 40 further includes an AND circuit 44 for inputting the cycle arrival signal 123, the monitoring control signal 103, and a fault state signal 124 and for outputting a cell inserting request signal 125, a cell generation information queue portion 45 for inputting the cell inserting request signal 125, a connection ID 45_1 (102), an OAM cell classification 45_2, a fault classification 45_3, and a line ID45_4 and for outputting 45_1′-45_4′, and a cell assembler 46 for inputting the signals 45_1′-45_4′ and for outputting an OAM cell 135. The OAM cell generator 40 further includes a cell inserter 47. This cell inserter 47 inputs the OAM cell 135 and an output cell flow 126 to determine whether or not the cell insertion is possible, inserts the OAM cell 135 into an output cell 127 when the cell insertion is possible, and transmits an insertion disable signal 132 to the cell assembler 46 when the insertion is impossible, thereby transmitting an insertion disable signal 133 to the queue portion 45.

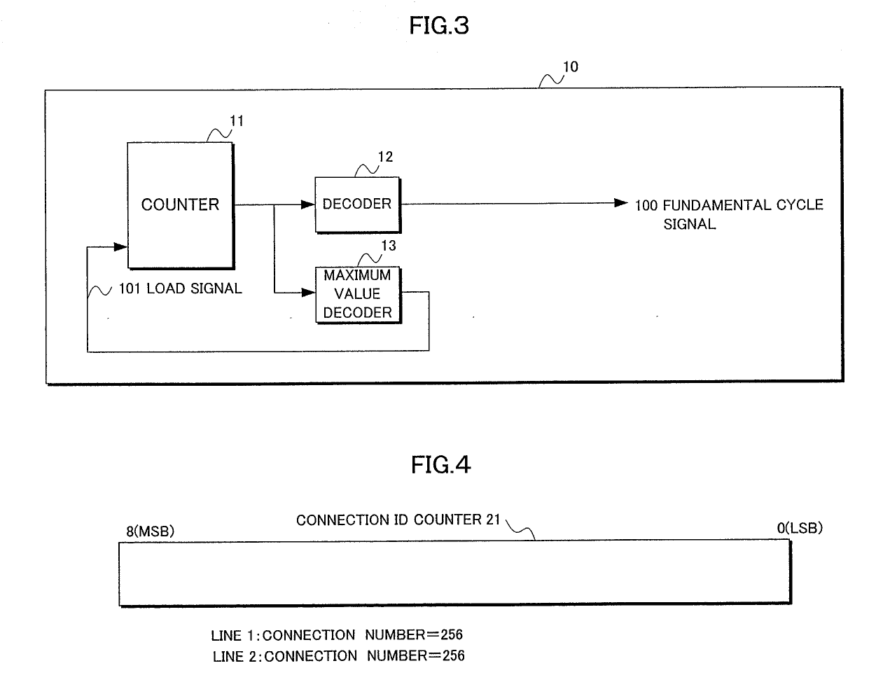

FIG. 3 shows an embodiment of the fundamental timer 10. This fundamental timer 10 counts up from e.g. “0”, returns to “0” when the count reaches the value designated at a maximum value decoder 13, and outputs the fundamental cycle signal 100 of a fixed cycle designated by the maximum value decoder 13 at the timing designated by a decoder 12.

This fundamental timer 10 is realized by a hard timer or a soft timer. The hard timer is realized by a counter.

FIG. 4 shows an arrangement of a connection ID counter 21 included in the connection ID generator 20 which counts the fundamental cycle signal 100.

The counter 21 is composed of 9 bits (MSB 8-LSB 0) enabling 512 connection ID's in total corresponding to the connection number of lines 1 and 2 to be outputted when the connection number of the lines 1 and 2 are respectively “256”. Thus, it becomes unnecessary to provide a counter for each of the lines 1 and 2, thereby reducing the cost.

Namely, it becomes possible to share the fundamental timer and the connection ID generator for a plurality of lines.

Since the operation of the alarm state timer monitor 30 in FIG. 2 is the same as that of the timer monitor 30 shown in FIG. 28, the description thereof will be omitted.

In the OAM cell generator 40, the cell generation cycle memory 41, the arithmetic unit 42, and the counter value determiner 43 count the monitoring control signal 103 by the counter corresponding to the connection ID in an address area designated by the connection ID in the same way as the operation of the alarm state timer monitor 30.

Namely, the memory 41 inputs the monitoring control signal 103 as a write enable signal 120, and stores data in which “1” is added at the arithmetic unit 42 in the counter built into the memory 41. When the counter value assumes a predetermined value, the determiner 43 outputs the cell generation cycle arrival signal 123 and clears the counter (clear circuit is not shown).

The AND circuit 44 transmits the cell inserting request signal 125 to the cell generation information queue portion 45, when the fault state signal 124 indicates a fault state which is a condition of an OAM cell generation, the cycle arrival signal 123 indicates a cycle arrival, and the monitoring control signal 103 indicates the validity of the connection ID signal 102.

It is to be noted that the condition of the OAM cell generation is one of VP-AIS cells, VP-RDI cells, VC-AIS cells, VC-RDI cells, and the like prescribed by the ITU-T, and a function for determining whether or not this condition is satisfied is not shown. The condition of the VP-AIS cell generation, for example, is as follows: The VP for accommodating the concerned VC connection is in a fault state and the VC is not a terminal point.

The queue portion 45 queues the connection ID signal 102 (occasionally, referred to as a reference numeral 45_1), the OAM classification 45_2, the fault classification 45_3, and the line ID 45_4.

When the insertion disable signal 133 does not indicate an insertion impossible, the queue portion 45 transmits a connection ID 45_1′, an OAM cell classification 45_2′, a fault classification 45_3′, and a line ID 45_4′ to the cell assembler 46, which requests the cell inserter 47 to insert the assembled OAM cell 135 into the output cell flow 126.

When the insertion is possible, the cell inserter 47 inserts the OAM cell 135 into the output cell flow 126 to output the output cell 127. When the insertion is impossible, the cell inserter returns the insertion disable signal 132 to the cell assembler 46.

By providing the queue portion 45, it becomes unnecessary to stop the operation of the fundamental timer. Thus, the accumulation of the queue times of the cell insertions is avoided, thereby enabling the accuracy of the monitor timer to be increased. Also, it becomes possible to share the fundamental timer 10 and the connection ID generator 20 in the alarm state timer monitor 30 and the OAM cell generator 40, thereby enabling the hardware cost to be reduced.

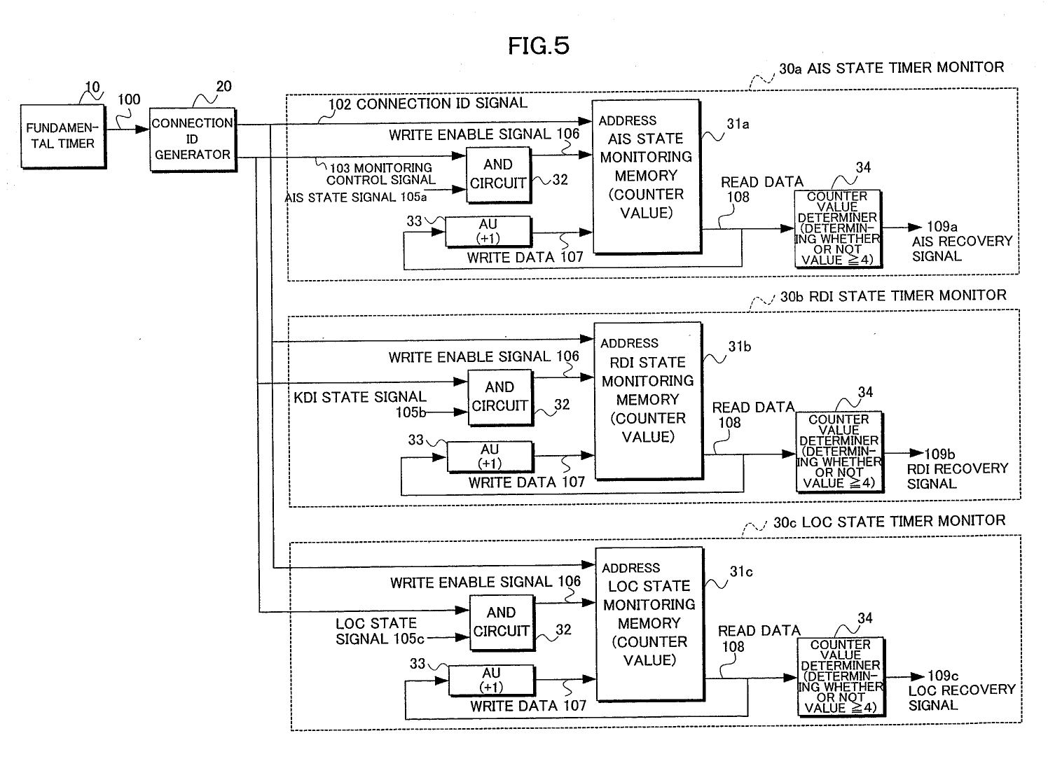

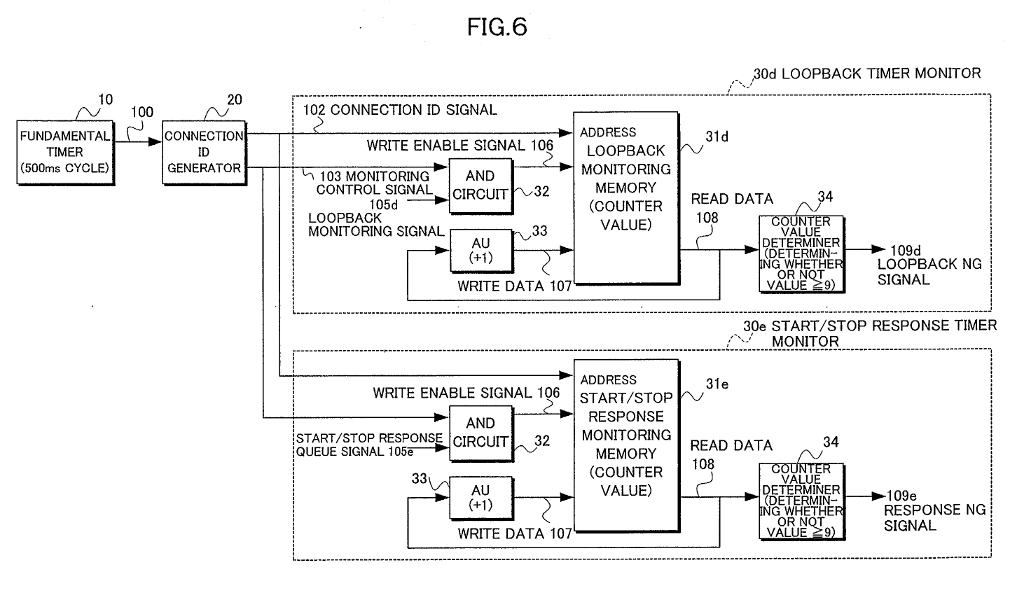

FIGS. 5 and 6 show embodiments of an AIS state timer monitor 30a, an RDI state timer monitor 30b, an LOC state timer monitor 30c (see FIG. 5 for these monitors), a loopback timer monitor 30d, and a start/stop response timer monitor 30e (see FIG. 6 for these monitors) where the “monitor states” of the alarm state timer monitor 30 shown in FIG. 2 are respectively made “AIS alarm state”, “RDI alarm state”, “LOC alarm state”, “loopback monitor”, and “start/stop response monitor”.

The timer monitors 30a-30e are different from the alarm state timer monitor 30 in that the monitoring signal (alarm state signal) 105 is changed to an AIS state signal 105a, an RDI state signal 105b, an LOC state signal 105c, a loopback monitoring signal 105d, and a start/stop response queue signal 105e corresponding to each monitor. Also, the alarm recovery signal 109 is changed to an AIS recovery signal 109a, an RDI recovery signal 109b, an LOC recovery signal 109c, a loopback NG signal 109d, and a response NG signal 109e corresponding to each monitor.

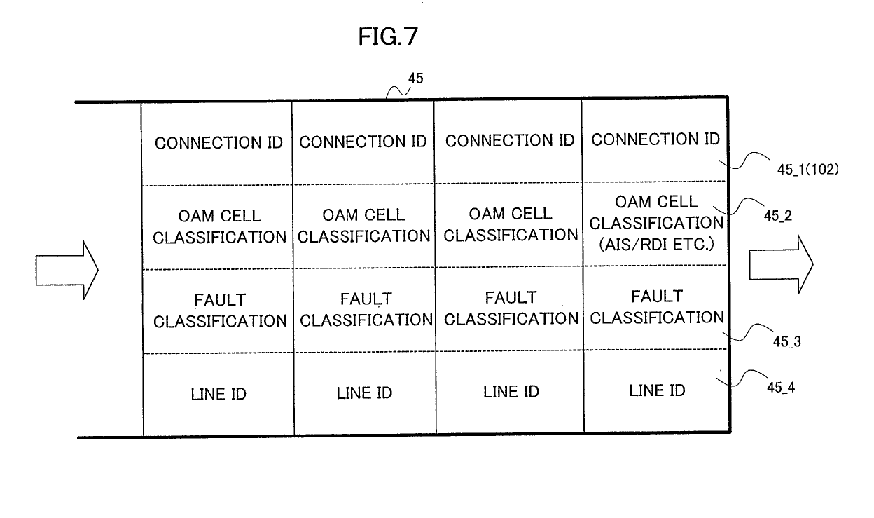

FIG. 7 shows an embodiment of the cell generation information queue portion 45 shown in FIG. 2. The queue portion 45 queues, from the left side of FIG. 7, the connection ID 45_1, the OAM cell classification 45_2, the fault classification 45_3, and the line ID 45_4, which are the minimum information required for composing an OAM cell, and transmits, from the right side of FIG. 7, the connection ID 45_1′, the OAM cell classification 45_2′ the fault classification 45_3′, and the line ID 45_4′ in a queued order.

The connection ID 45_1, the OAM cell classification 45_2, the fault classification 45_3, and the line ID 45_4 are coded in order to decrease the memory capacity.

In the presence of two kinds of the OAM cell classification 45_2 such as an End-to-End AIS cell and an End-to-End RDI cell, the OAM cell classification 45_2 is coded by 1 bit. In the presence of three kinds of the fault classification 45_3 such as a physical layer fault, a VP layer fault, and an LOC fault, the fault classification 45_3 is coded by 2 bits. In the presence of 32 lines, the line ID 45_4 can be coded by 5 bits.

Thus, the memory capacity required by the queue portion 45 can be reduced.

It is to be noted that when there is a single line, the line ID 45_4 can be omitted.

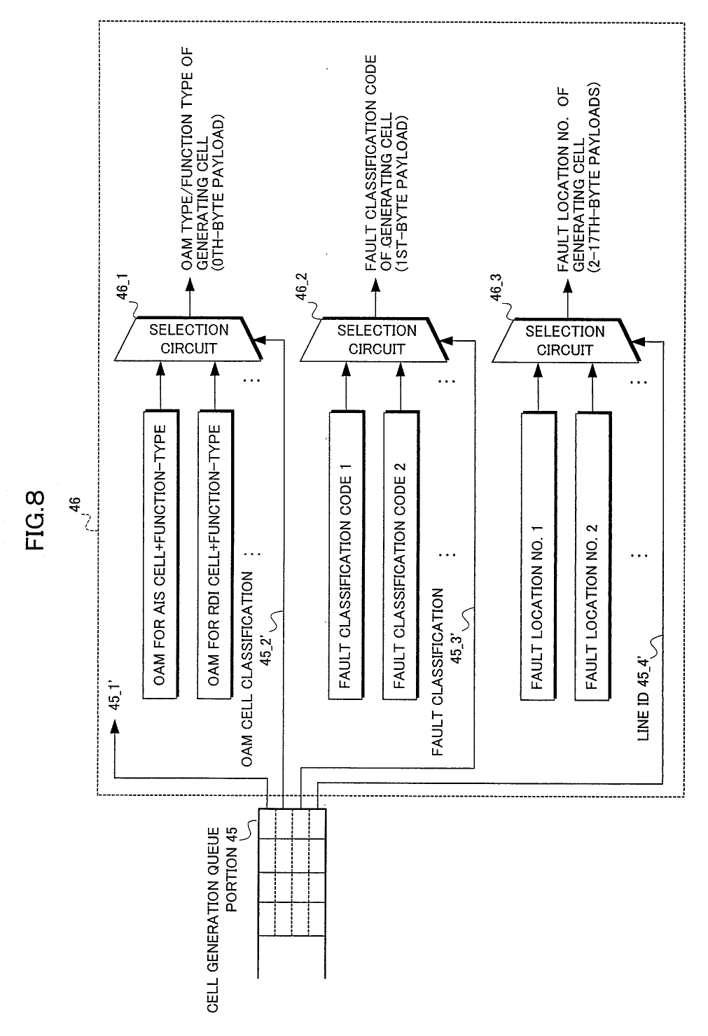

The embodiment of the cell assembler 46 shown in FIG. 2 will be described referring to FIG. 8, where the queue portion 45 is also shown which provides the connection ID 45_1′, the OAM cell classification 45_2′, the fault classification 45_3′, and the line ID 45_4′ to the cell assembler 46.

The cell assembler 46 includes selection circuits 46_1-46_3. The selection circuit 46_1 selects one of an OAM cell for AIS cell+function-type 1, OAM cell for AIS cell+function-type 2, . . . , by the coded OAM cell classification 45_2′ to be outputted as an OAM type+function type signal, so that the selected OAM type+function type is inserted into 0th byte of the payload portion of the assembled OAM cell (not shown).

The selection circuit 46_2 selects one of a fault classification code 1, a fault classification code 2, . . . , by the coded fault classification 45_3′ to be outputted as a fault classification code signal of a generating cell, so that the fault classification code is inserted into 0th byte of the payload portion of the assembled OAM cell.

The selection circuit 46_3 selects one or more of a fault location No. 1, a fault location No. 2, . . . , by the coded line ID 45_4′ to be outputted as a fault location No. signal of the generating cell, so that the fault location No. is inserted into the 2nd-17th bytes of the payload portion of the assembled OAM cell.

Also, the cell assembler 46 finds the connection to which the OAM cell is inserted from the connection ID 45_1′ to be notified to the cell inserter 47 (not shown).

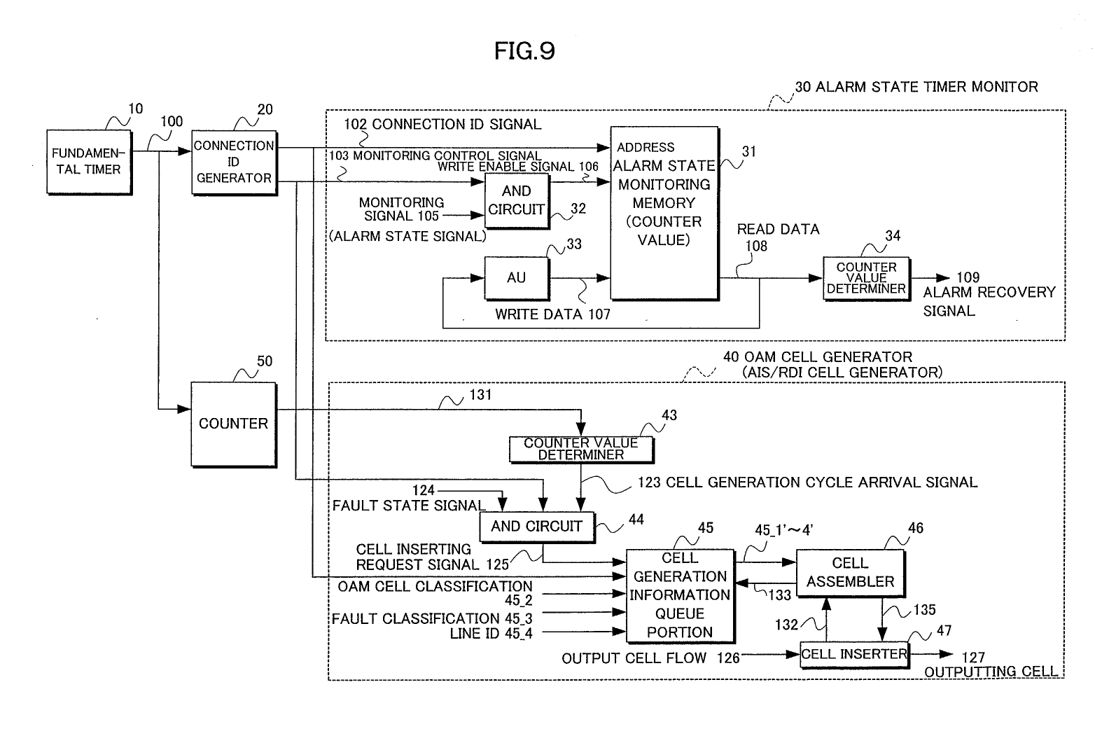

FIG. 9 shows an embodiment (2) of the ATM communication monitoring device according to the present invention. This ATM communication monitoring device is composed of the fundamental timer 10, the connection ID generator 20, the alarm state timer monitor 30, a counter 50, and the OAM cell generator 40.

This arrangement is different from the embodiment (1) of FIG. 2 in that the counter 50 is added which counts the output signal 100 of the fundamental timer 10 and provides a count 131 to the OAM cell generator 40.

The arrangement of the alarm state timer monitor 30 is the same as that of the alarm state timer monitor 30 in FIG. 2, and the operation of the alarm state timer monitor 30 is the same as that of the alarm state timer monitor 30 in FIG. 2.

The arrangement of the OAM cell generator 40 is different from the OAM cell generator 40 of FIG. 2 in that the cell generation cycle memory 41 and the arithmetic unit 42 are removed and the count 131 of the counter 50 is inputted to the counter value determiner 43.

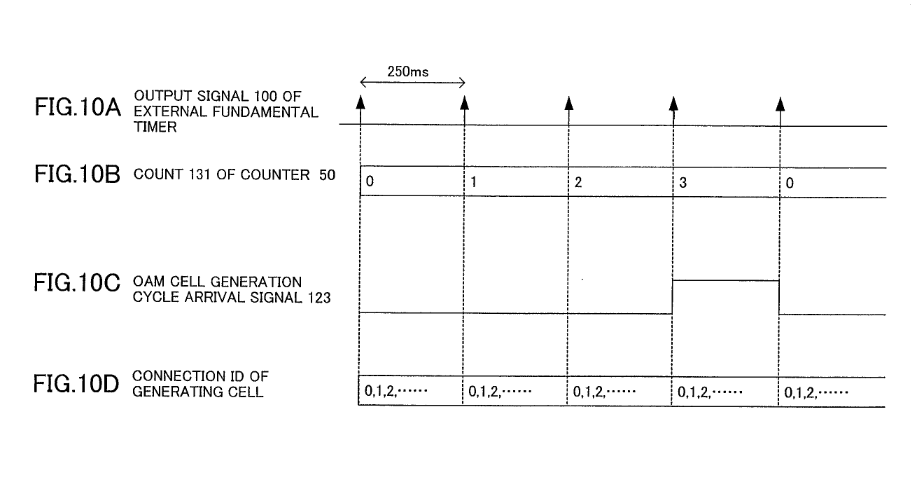

FIGS. 10A-10D show operation timing examples of the OAM cell generator 40.

The fundamental timer 10 firstly outputs the fundamental cycle signal 100 in a cycle of e.g. 250 ms (FIG. 10A). The counter 50 counts this output signal 100 to output the count 131 (FIG. 10B).

The counter value determiner 43 outputs the cell generation cycle arrival signal 123 every time the count 131 assumes e.g. “3”. Namely, the cycle arrival signal 123 is outputted every 250 ms×4=1 second (FIG. 10C) to be provided to the AND circuit 44. FIG. 10D shows a timing of the connection ID signal 102.

The embodiments of the AND circuit 44, the queue portion 45, the cell assembler 46, and the cell inserter 47 are the same as those in FIG. 2. Namely, the OAM cell of the connection requiring the OAM cell generation designated by the fault state signal 124 and the connection ID signal 102 is inserted into the output cell flow 126 at the timing of the cycle arrival signal 123 produced every one second and of the connection ID.

In the embodiment (2), the counter 50 also serves as a counter for determining whether or not all of the connections have reached the cell generation cycle. Therefore, the cell generation cycle memory 41 which sets the counter corresponding to each connection ID in the embodiment (1), for example, becomes unnecessary, thereby enabling the hardware cost to be reduced.

It is to be noted that in FIGS. 10A-10D the timing to generate the OAM cell is supposed to be the time when the counter 50 indicates “3”. However, the connection may be classified into four groups based on the connection ID, and the timing to generate the OAM cell may assume the time when the counter value is “0”-“3”, thereby enabling the cell generation timing to be dispersed.

Thus, it becomes possible to generate the OAM cells at different generation cycles and dispersed timings, and to adapt to the generation cycle, thereby increasing success probability in the cell generation.

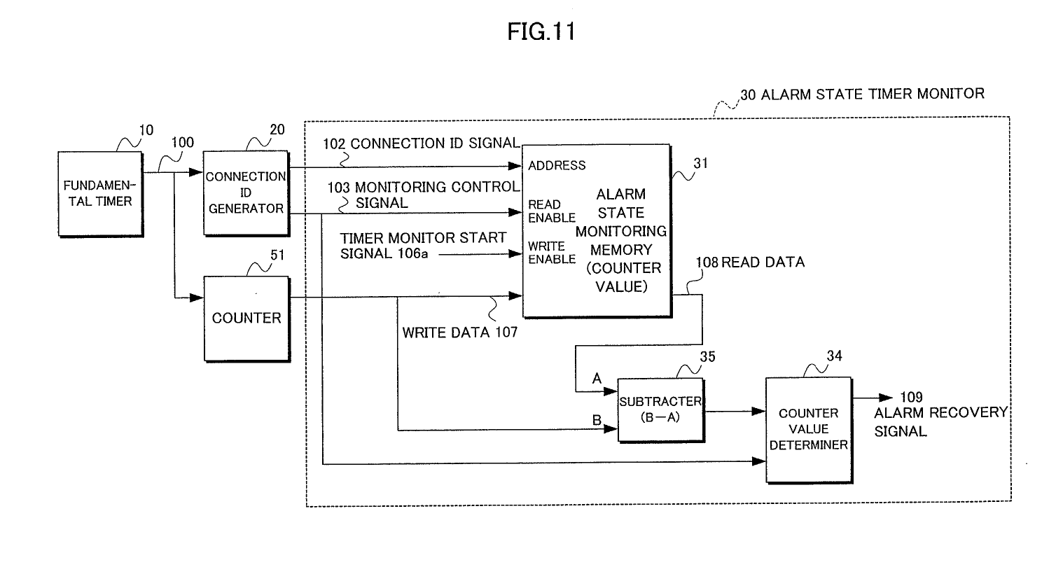

FIG. 11 shows a modification (1) of the alarm state timer monitor 30.

In this embodiment, the fundamental timer 10 and the connection ID generator 20 are used in the same way as the monitor 30 of the embodiment in FIG. 2. However, in FIG. 11, a counter 51 which counts the output signal 100 of the fundamental timer 10 is provided at a preceding stage of the timer monitor 30. It is to be noted that the cost reduction can be realized by sharing the counter 51 with the counter 50 in FIG. 9.

The alarm state timer monitor 30 is composed of the alarm state monitoring memory 31 for inputting the connection ID signal 102, the monitoring control signal 103, a timer monitor start signal 106a, and a counter value (write data) 107 of the counter 51 to the terminals of the address, the read enable, the write enable, and the input data and for outputting the read data 108, a subtracter 35 for inputting the write data 107 and the read data 108 and for subtracting the read data 108 from the write data 107, and the counter value determiner 34 for inputting a subtraction result and the monitoring control signal 103 and for outputting the alarm recovery signal 109.

In operation, the memory 31 stores the present counter value (write data) 107 of the counter 51 in the address designated by the connection ID signal 102 with the timer monitor start signal 106a of each connection ID produced corresponding to the connection ID signal 102.

The subtracter 35 computes “write data 107 (present count)”−“read data 108 (stored count: this is a past counter value” in synchronization with the signal 100.

When the subtraction result and the monitored counter value (not shown) set per each connection ID are compared and found equal, the counter value determiner 34 determines that the counter value has reached the monitor cycle to output the alarm recovery signal 109.

Thus, the memory 31 executes only the operation of storing the past counter value of the counter 51 per connection ID, thereby unnecessitating the counter operation of the memory 31 in FIG. 2. Accordingly, the frequency of the write access to the memory 31 is decreased, the consumption power of the memory is reduced, and its longevity is prolonged.

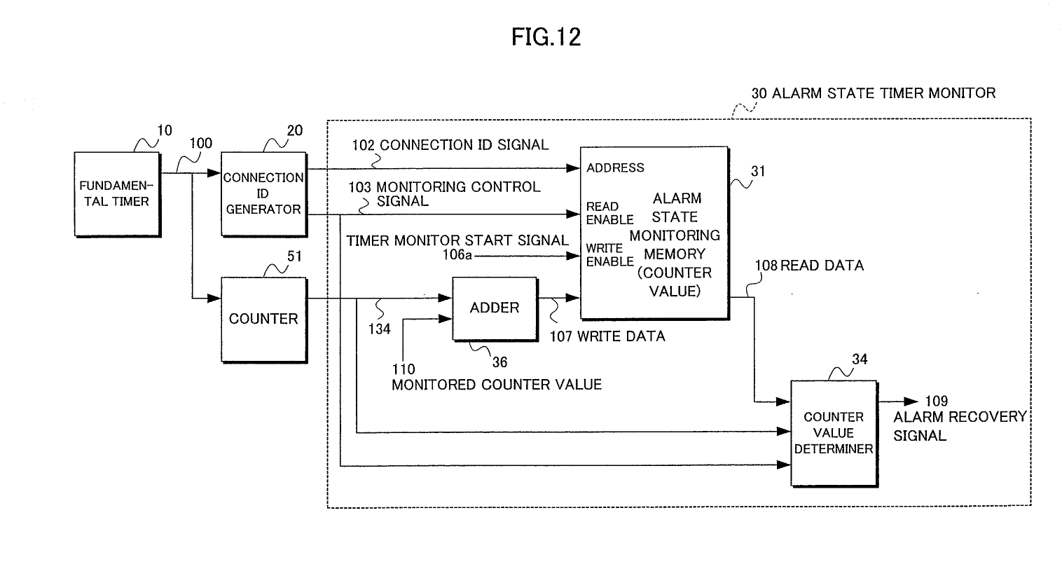

FIG. 12 shows a modification (2) of the alarm state timer monitor 30.

This embodiment is the same of that of FIG. 11 in that the fundamental timer 10 and the connection ID generator 20 are used, and the counter 51 is provided at the preceding stage of the timer monitor 30. Also, the counter 51 and the counter 50 of FIG. 9 can be shared.

The alarm state timer monitor 30 is different from the arrangement of FIG. 11 in that an adder 36 is substituted for the subtracter 35, which inputs a monitored counter value 110 and a count 134 of the counter 51 and provides the write data 107 as the addition result to the data input terminal of the memory 31. Also, the monitor 30 is different from the arrangement of FIG. 11 in that the read data 108 from the memory 31, the count 134, and the monitoring control signal 103 are inputted to the counter value determiner 34.

In operation, the adder 36 adds the monitor counter value 110 to the present count 134 of the counter 51, and computes the count of the counter 51 after the time of the monitored counter value 110 has elapsed, so that the memory 31 stores the value (write data 107) at the timing of the timer monitor start signal 106a corresponding to each connection ID.

The counter value determiner 34 compares the counter value (read data 108) from the memory 31 with the present count 134 of the counter 51 at the timing when the monitoring control signal 103 indicates the validity of the connection ID, and outputs the alarm recovery signal 109 corresponding to the connection ID.

Thus, in the same way as the modification (2) of FIG. 11, the write access frequency to the memory 31 and the consumption power of the memory 31 are reduced, and its longevity is prolonged.

It is to be noted that the monitored counter value 110 is assumed to be a variable value corresponding to the connection ID, while it can be a fixed value common to all of the connections.

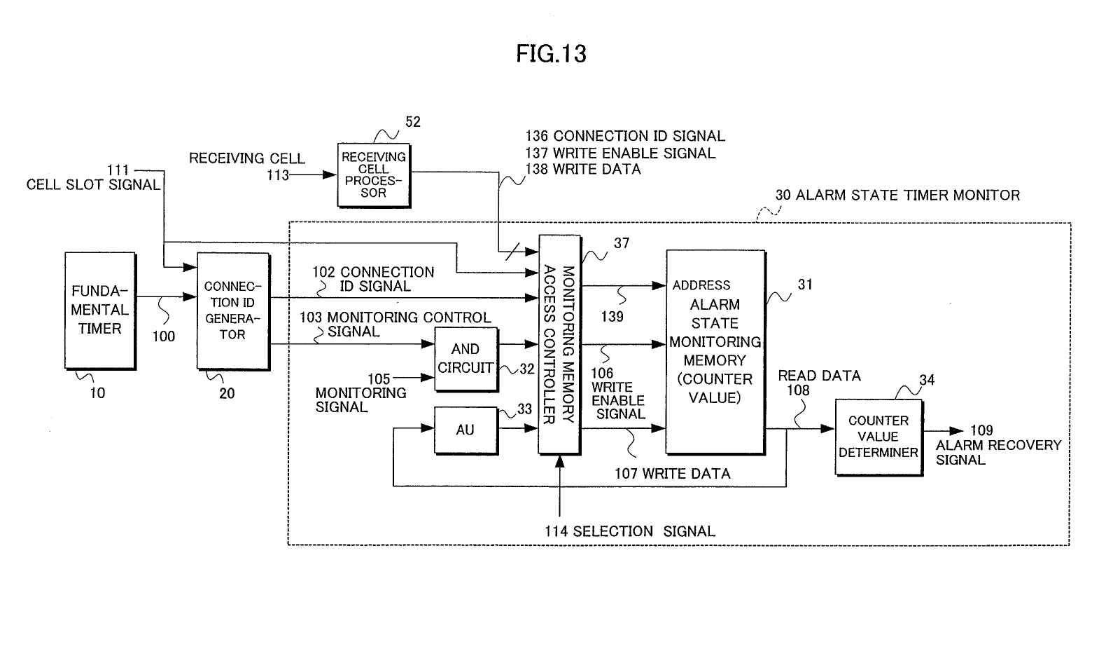

FIG. 13 shows a modification (3) of the alarm state timer monitor 30.

This monitor 30 is different from that shown in FIG. 2 in that a monitor memory access controller 37 is provided at the preceding stage of the alarm state monitoring memory 31.

The access controller 37 inputs the connection ID signal 102 given to the memory 31, the write enable signal 106, and the write data 107 as shown in FIG. 2, as well as a cell slot signal 111, a selection signal 114, a connection ID signal 136 from a receiving cell processor 52, a write enable signal 137, and a write data 138.

Also, the connection ID generator 20 in this embodiment inputs the cell slot signal 111 and operates in synchronization with this signal 111.

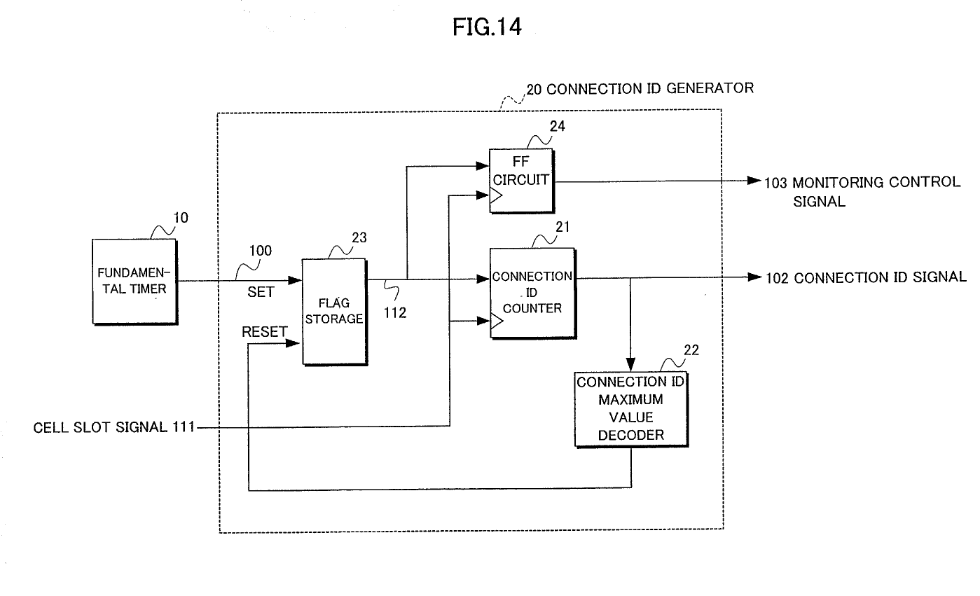

FIG. 14 shows an embodiment (1) of the connection ID generator 20 shown in FIG. 13. This ID generator 20 is composed of a flag storage 23 for storing a flag signal 112 which becomes a set state with the output signal 100 of the fundamental timer 10 and a reset state with a reset signal and for outputting the signal, an FF circuit 24 for outputting the flag signal 112 as the monitoring control signal 103 in synchronization with the cell slot signal 111, a connection ID counter 21 for synchronizing with the cell slot signal 111 when the flag signal 112 indicates the set state and for outputting the connection ID signal 102 which has counted the cell slot signal 111, and a connection ID maximum value decoder 22 for inputting the connection ID signal 102, for detecting a predetermined maximum value of the connection ID, and for providing the reset signal to the flag storage 23.

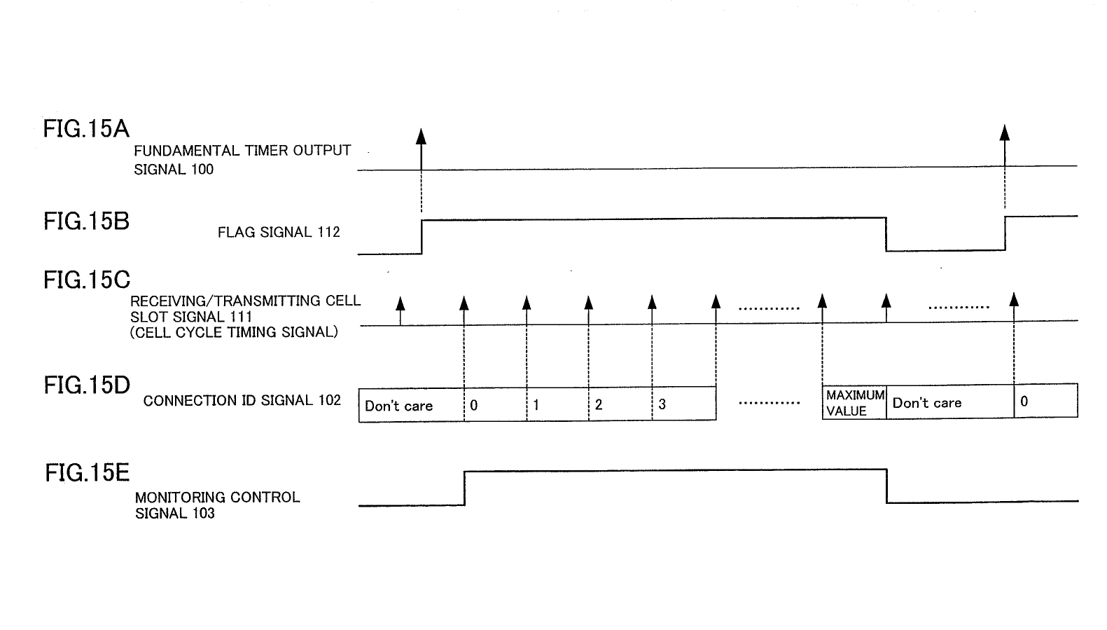

FIGS. 15A-15E show operation timing examples of the connection ID generator 20.

FIG. 15A shows an output signal 100 of the fundamental timer 10. The output signal 100 is a pulse signal of e.g. 250 ms cycle. FIG. 15B shows a flag signal 112 and is set to “1” per signal 100. FIG. 15C indicates a cell slot signal 111, which is counted by the counter 21 to produce the connection ID signal 102 of FIG. 15D.

The maximum value decoder 22 detects that connection ID signal 102 assumes a predetermined maximum value, and provides the reset signal which makes the flag signal 112 “0” to the flag storage 23.

The monitoring control signal 103 shown in FIG. 15E is a signal which synchronizes with the flag signal 112 by the cell slot signal 111, and indicates a valid section of the connection ID signal 102.

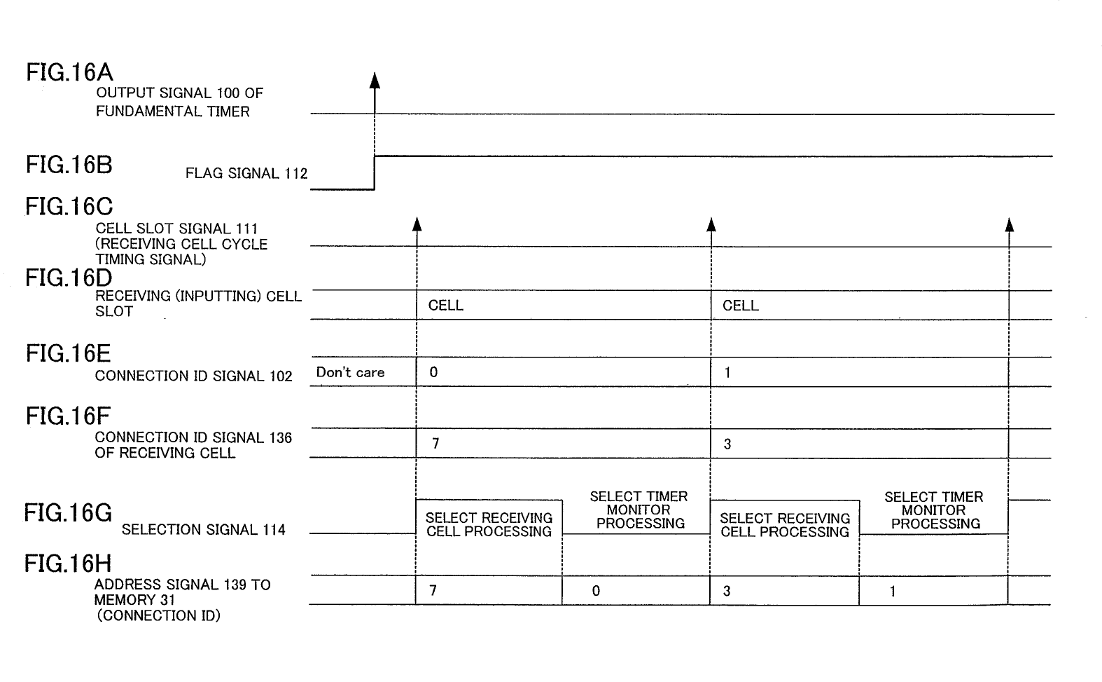

FIGS. 16A-16H show operation timing examples of the alarm state timer monitor 30 shown in FIG. 13. The operation of the monitor 30 will be described referring to FIGS. 16A-16H.

FIGS. 16A-16C respectively show the output signal 100 of the fundamental timer, the flag signal 112, and the cell slot signal 111 shown in FIGS. 15A-15C. FIG. 16D shows a receiving cell slot, which synchronizes with the cell slot signal 111.

FIG. 16E shows a connection ID signal 102 which sequentially varies in synchronization with the cell slot signal 111 like “0”, . . . FIG. 16F shows a connection ID signal 136, which sequentially varies in synchronization with the cell slot signal 111 like “7”, “3”, . . . FIG. 16G shows a selection signal 114, which divides the cell slot signal 111 into two, a cell processing selection section for the first half and a timer monitor processing section for the second half.

FIG. 16H shows an address signal 139 outputted from the access controller 37. This address signal 139 is signals “7”, “0”, “3”, “1”, . . . which are the connection ID signals 102 and 136 respectively selected by the selection signal 114.

Also, the access controller 37 switches over the write enable signal 106 and the write data 107 from the receiving cell processor 52 to ones from the timer monitor 30 by the selection signal 114 as well as the address signal 139, and outputs the same.

Thus, it becomes possible to isolate the counter value designated by the connection ID signals 102 and 136 into the receiving cell processing and the timer monitor processing for accessing the memory 31.

For example, the counter corresponding to the connection ID=“7” requiring a reset within the selection section of each receiving cell processing can be reset to “0”.

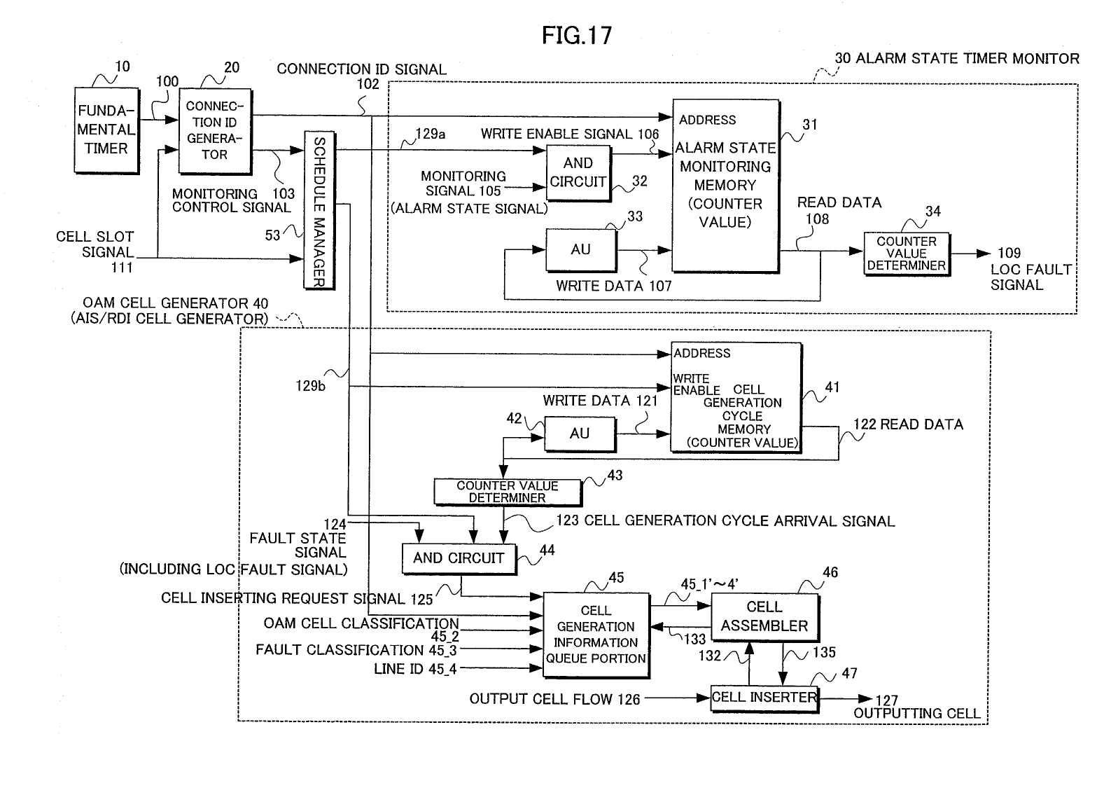

FIG. 17 shows an embodiment (3) of the ATM communication monitoring device according to the present invention.

The basic arrangement of this embodiment is the same as the embodiment (1) shown in FIG. 2. However, while the connection ID generator 20 inputs only the output signal 100 from the fundamental timer 10 in FIG. 2, the same connection ID generator 20 as that shown in FIG. 14 which operates in synchronization with the cell slot signal 111 is used in FIG. 17.

Also, it is different from the embodiment (1) in that a schedule manager 53 is added for inputting the monitoring control signal 103 and the cell slot signal 111 and for providing output signals 129a and 129b respectively to the alarm state timer monitor 30 and the OAM cell generator 40.

It is to be noted that the basic arrangement of the alarm state timer monitor 30 and the OAM cell generator 40 is the same as that of the embodiment (1) shown in FIG. 2.

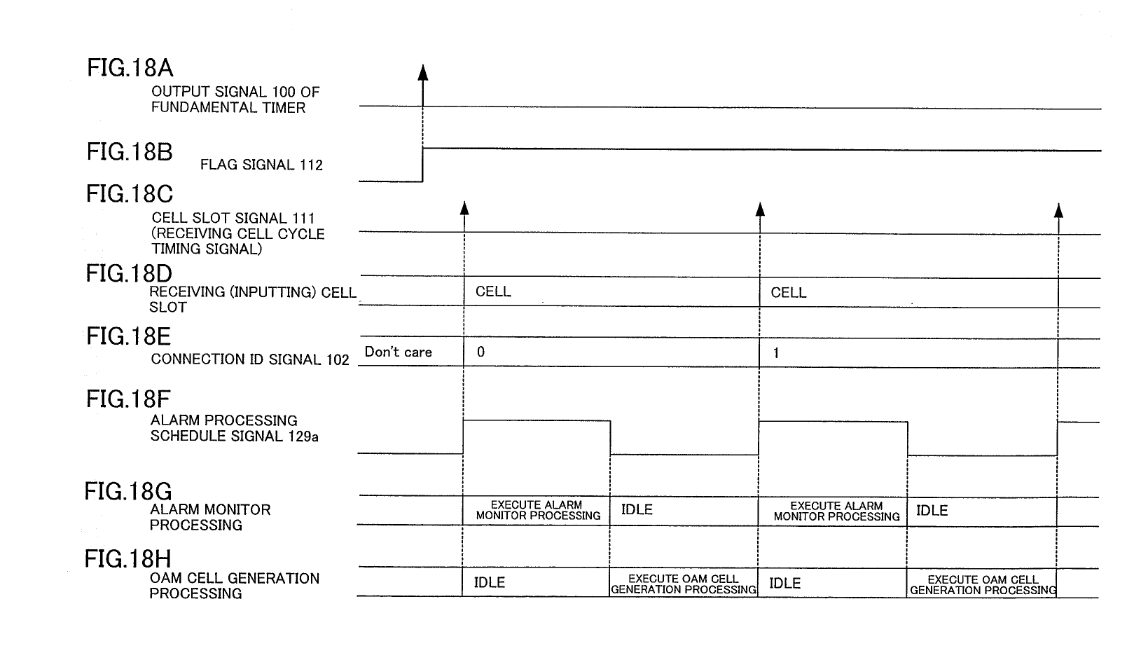

FIGS. 18A-18H show operation timings of the ATM communication monitoring device in FIG. 17. Hereinafter, the operation of the ATM communication monitoring device will be described referring to FIGS. 18A-18H.

The output signal 100 of the fundamental timer in FIG. 18A, the flag signal 112 in FIG. 18B, the receiving cell slot signal 111 in FIG. 18C, the cell slot in FIG. 18D, and the connection ID signal 102 in FIG. 18E respectively correspond to the signals 100, 112, 111, the cell slot, and the signal 102 shown in FIGS. 16A-16E.

The alarm processing schedule signal 129a in FIG. 18F becomes “1” in the first half section of the cell slot signal 111 when the monitoring control signal 103 is “1”, and indicates a timing when the alarm monitor processing can be executed. Namely, the alarm state timer monitor 30 executes the alarm monitor processing corresponding to each connection ID at the timing shown in FIG. 18G.

The signal 129b in FIG. 17 becomes “1” when the monitoring control signal 103 is “1” and the signal 129a is “0”. The OAM cell generator 40 executes the OAM cell generation processing at the timing shown in FIG. 18H when the signal 129b is “1”.

Namely, after executing the alarm monitor processing of the connection ID=“0”, the OAM cell generation processing of the same connection ID=“0” is executed, and then the alarm monitor processing and the OAM cell generation processing are sequentially executed for each connection ID in the same manner.

Thus, at the stage of detecting the alarm state by the alarm monitor processing, it becomes possible to immediately generate the OAM cell corresponding to the connection ID designated by the connection ID signal 102 in the OAM cell generation processing, and inversely to stop the OAM cell generation immediately after detecting the alarm recovery by the alarm monitor processing.

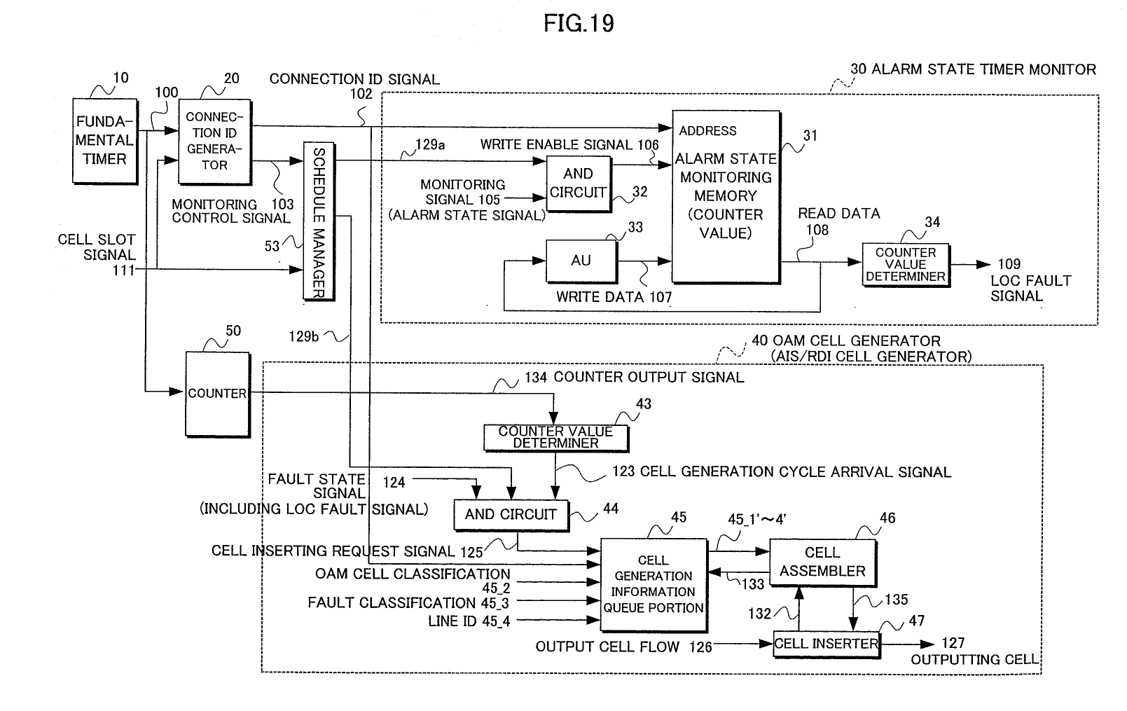

FIG. 19 shows an embodiment (4) of the ATM communication monitoring device according to the present invention. The basic arrangement of this ATM communication monitoring device is the same as the embodiment (3) shown in FIG. 17. However, the same OAM cell generator 40 as in FIG. 9 is used, and the counter 50 is provided at the preceding stage of the OAM cell generator 40.

The operation is the same as that of the embodiment in FIG. 17. The alarm monitor processing and the OAM cell generation processing are executed by time-sharing at the timing designated by the schedule manager 53. For the execution order, it is possible to generate the OAM cell or to stop the generation immediately after detecting the alarm state or the alarm recovery.

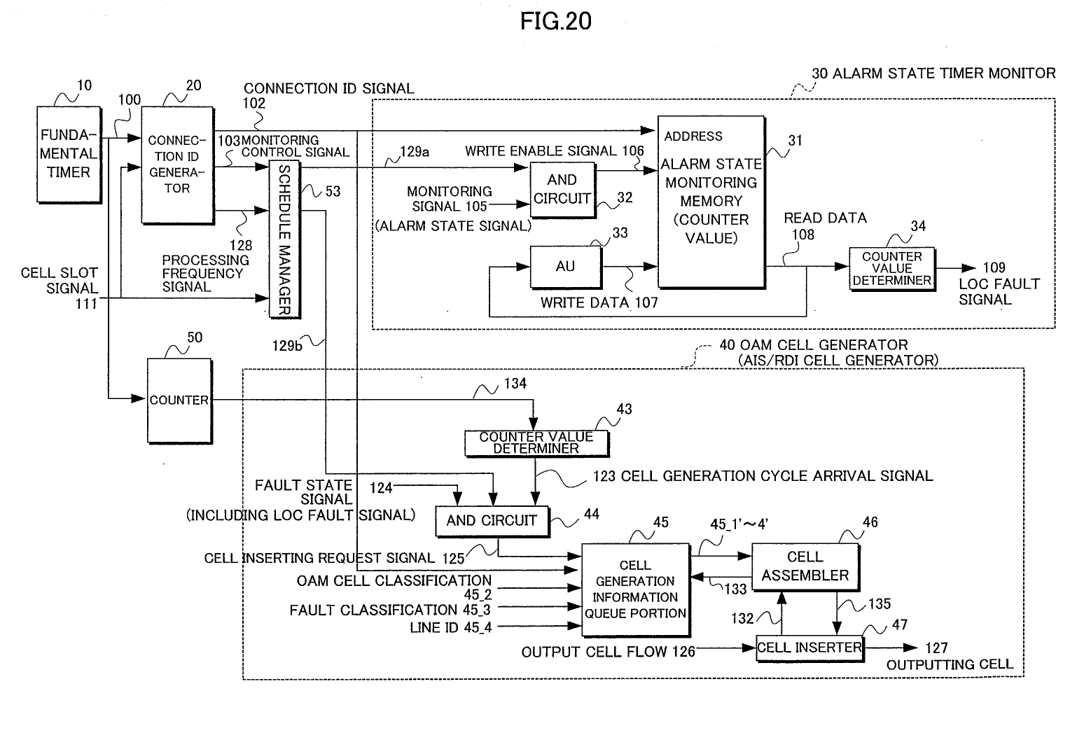

FIG. 20 shows an embodiment (5) of the ATM communication monitoring device according to the present invention. The basic arrangement of this ATM communication monitoring device is the same as that of FIG. 19 except that the connection ID generator 20 outputs a processing frequency signal 128 to be provided to the schedule manager 53.

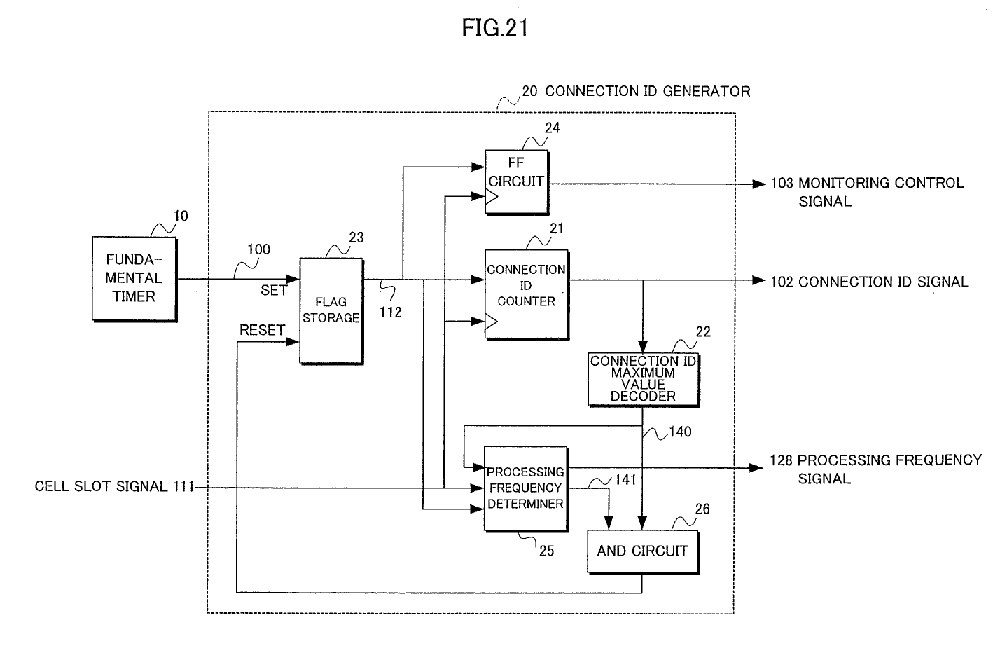

FIG. 21 shows an embodiment (2) of the connection ID generator 20. In this connection ID generator 20, a processing frequency determiner 25 and an AND circuit 26 are further added to the connection ID generator 20 shown in FIG. 14.

The connection ID generator 20 provides an output signal 140 of the connection ID maximum value decoder 22, not to the flag storage 23 but directly to the processing frequency determiner 25 and the AND circuit 26. The processing frequency determiner 25 further inputs the cell slot signal 111 and the flag signal 112 to output the processing frequency signal 128 and a signal 141 indicating the arrival of the maximum processing frequency.

Also, the AND circuit 26 further receives the signal 140 and provides the reset signal to the flag storage 23.

In operation, the connection ID generator 20 outputs the same connection ID signal 102 and the monitoring control signal 103 as those of the connection ID generator 20 in FIG. 14. The processing frequency determiner 25 counts the cycle frequency of the connection ID by counting the signal 140 and outputs the count as the processing frequency signal 128. When the cycle frequency has reached a predetermined maximum cycle frequency, the processing frequency determiner 25 sets the signal 141 to “1”.

When the signals 140 and 141 are both “1”, the AND circuit 26 provides the reset signal to the storage 23 to make the flag signal 112 “0”.

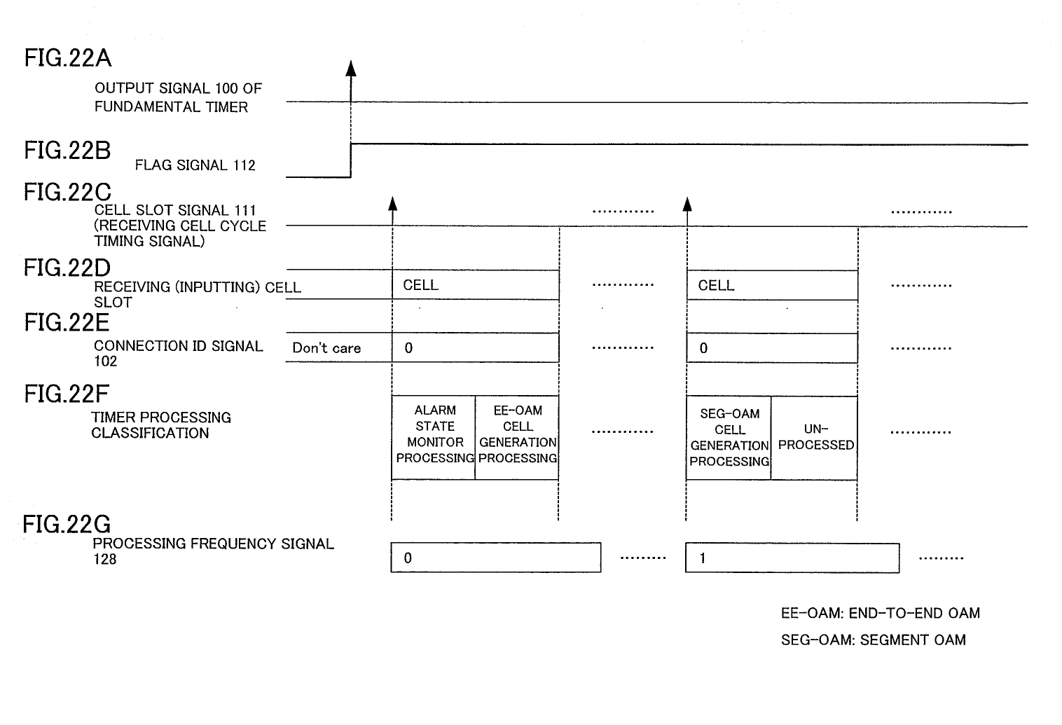

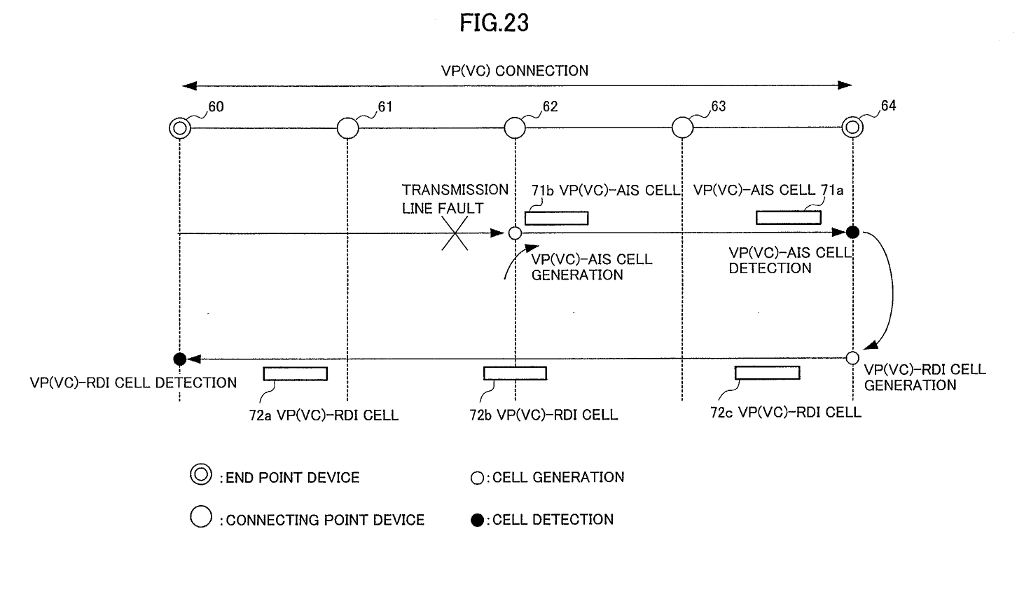

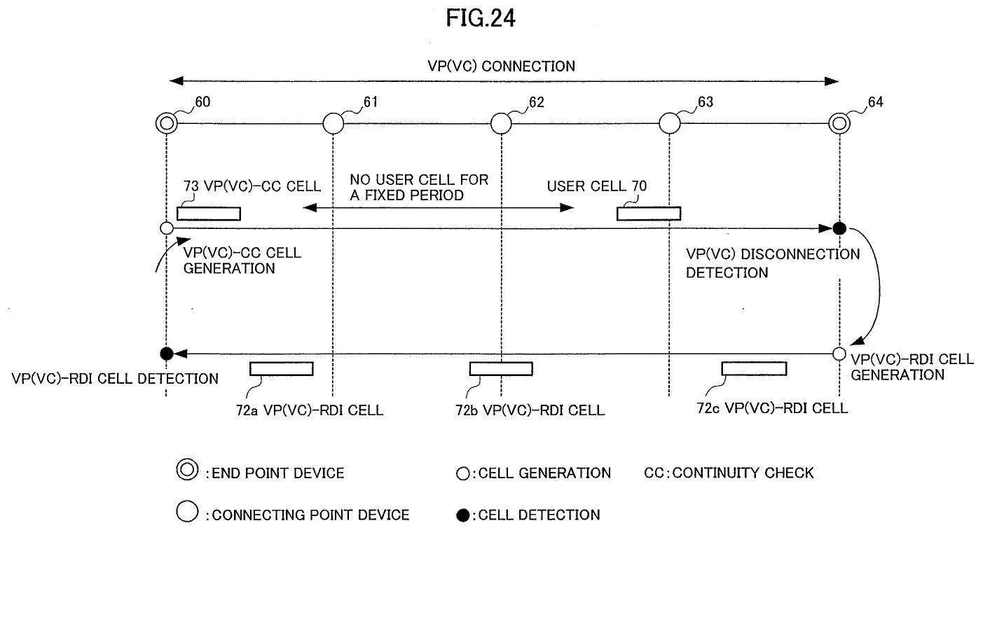

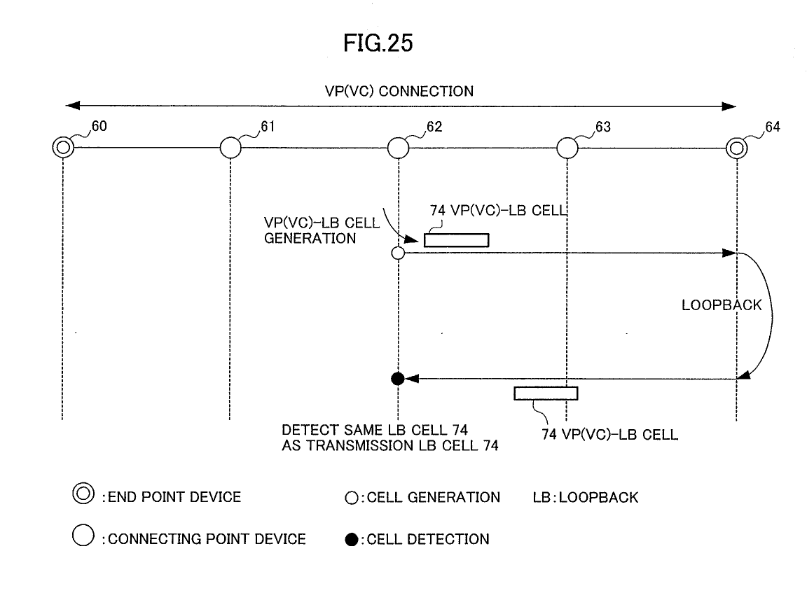

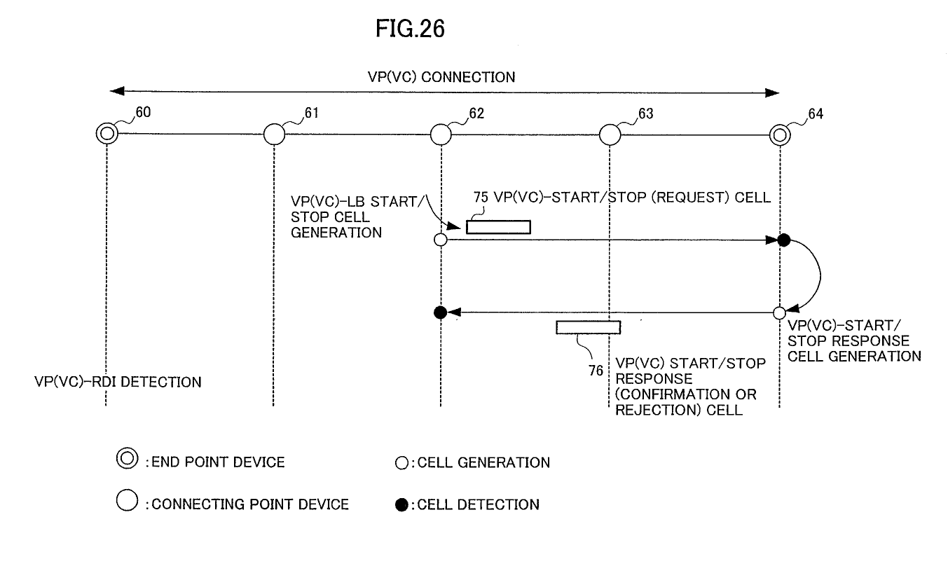

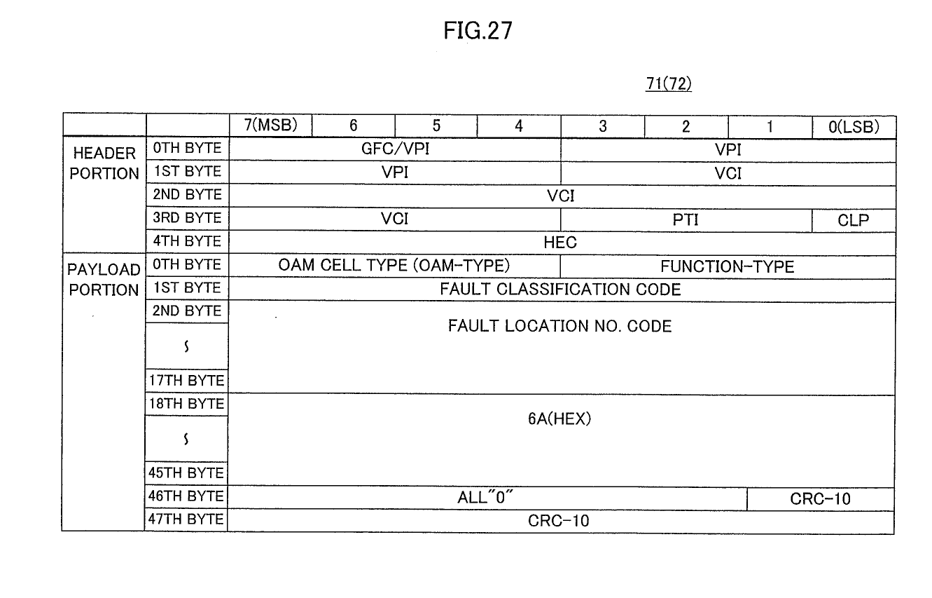

FIGS. 22A-22G show operation examples of the ATM communication monitoring device in FIG. 20. The output signal 100 from the fundamental timer, the flag signal 112, the cell slot signal 111, the cell slot, and the connection ID signal 102 in FIGS. 22A-22E respectively correspond to the signals in FIGS. 18A-18E.

The processing frequency signal 128 in FIG. 20 sequentially varies in cycle of “0”, “1”, . . . “maximum cycle frequency N (N is a natural number)−1”, “0”, . . . In this embodiment, the function of the schedule manager 53 is expanded so that the alarm monitor processing and the OAM cell generation processing are performed N times separately.

Namely, the schedule manager 53 prepares signals 129a and 129b produced by dispersing the timings when the connection ID signal 102 becomes valid into N cycles based on the cell slot signal 111, the processing frequency signal 128, and the monitoring control signal 103, and provides the signals respectively to the AND circuits 32 and 44.

The processing frequency signal 128 of FIG. 22G shows a case where the connection ID signal is cycled two times, and the processing frequency signal 128 sequentially varies in cycle of “0”, “1”, “0”, “1”, . . .

The connection ID signal 102 in FIG. 22E repeats “0”, “1”, . . . “maximum decoder number−1” within the sections of processing frequency signal 128=“0” and “1”. However, in FIG. 22E, only the section of “0” is shown.

FIG. 22F shows a classification of the timer processing. In this embodiment, the section of the processing frequency signal 128=“0” and the connection ID signal 102=“0” is further divided into sections of the first half and the second half as with the case of FIG. 18, an alarm state monitor processing is executed in the first half section, and an EE-OAM cell generation processing is executed in the second half section.

In the first half section where the processing frequency signal 128 =“1” and the connection ID signal 102=“0”, an SEG-OAM cell generation processing is executed and no processing is performed in the second half section.

The SEG-OAM cell is a Segment-OAM cell added in the ITU-T assembly in June 1998, and there is a case where the SEG-OAM cell is generated with an EE (End-End)-OAM cell per a single connection.

In this embodiment, the schedule manager 53 controls to perform a generation processing of the EE-OAM cell at the first cycle and the generation processing of the SEG-OAM cell at the second cycle. Accordingly, the cell generation information queue portion 45 has only to store the information of 1 cell (EE-OAM cell) at the maximum per a single connection at the first processing, and store the information of a single cell (SEG-OAM cell) at the maximum per a single connection at the second processing.

Accordingly, compared with the case where the EE-OAM cell and the SEG-OAM cell are generated at one cycle without being dispersed, the information amount stored in the queue portion 45 can be reduced and the probability of occurrence of a queue overflow is reduced. As a result, the required memory capacity of the queue portion 45 can be reduced.

As described above, an ATM communication monitoring device according to the present invention is arranged such that a connection ID generator generates connection ID's, and an OAM cell generator queues connection information of an OAM cell to be generated corresponding to the connection ID's at a predetermined cycle where a fundamental cycle signal is counted and generates the OAM cell. Therefore, an accumulation of a queue time of a cell insertion is eliminated, thereby enabling an accuracy of a monitor timer to be increased.

Also, the ATM communication monitoring device according to the present invention is arranged such that a counter counts the fundamental cycle signal, and an OAM cell generator queues connection information of an OAM cell corresponding to the connection ID's at a predetermined cycle based on a value of the counter and generates the OAM cell. Therefore, it becomes unnecessary to prepare a counter for each connection ID, thereby enabling the reduction of the cost.

Also, if an alarm state timer monitor counts the fundamental cycle signal per each connection ID and monitors whether or not a monitor state of a connection of each connection ID is held for a predetermined time, a fundamental timer, and a connection ID generator for an alarm state monitor and a fundamental timer, and a connection ID generator for an OAM cell generation can be shared, thereby enabling the cost reduction of the hardware.

Also, if a counter generates the connection ID for a plurality of lines in the connection ID generator, it becomes unnecessary to provide the connection ID generator per each line, thereby enabling the cost reduction.

Also, if the connection information comprises at least connection ID information, generated OAM cell classification information, and fault classification information, as well as line ID information for a plurality of lines, it becomes unnecessary to queue all of the information of the OAM cell corresponding to the connection ID, thereby decreasing a required memory capacity and enabling the cost reduction.

Also, by coding each information, the required memory capacity can be further reduced.

Also, if the alarm state timer monitor is composed of an alarm state monitoring memory for storing the counter value of the fundamental cycle signal with a timer monitor start signal, a subtracter for computing a difference between a present counter value and the stored counter value, and a counter value determiner for comparing the difference with a predetermined monitored counter value and for determining whether or not a monitor state is held for a predetermined time, a write access frequency to the alarm state monitoring memory and the consumption power of the memory are decreased, and its longevity is prolonged.

Also, if the alarm state timer monitor is composed of a counter for counting the fundamental cycle signal, an adder for adding the counter value to a predetermined monitored counter value, an alarm state monitoring memory for storing an arithmetic result of the adder with a timer monitor start signal, and a counter value determiner for comparing the stored counter value with a present counter value and for determining whether or not a monitor state is held for a predetermined time, the consumption power of the alarm state monitoring memory is decreased, and its longevity is prolonged.

Also, if a monitoring memory access controller in the alarm state timer monitor is composed so as to select by time-sharing an access to the alarm state monitoring memory based on a processing result from a processor of a receiving cell or an access to the alarm state monitoring memory by a timer monitor processing of the alarm state timer monitor, it becomes possible to avoid access competition to the memory for counter which occurs at random and contradiction occurrence in the information held in the memory.

Also, if a schedule manager manages, by time-sharing, timings for an alarm monitor processing and for an OAM cell generation processing, by managing the schedule so that the OAM cell generation processing is performed after the alarm monitor processing, for example, the time until the OAM cell generation after the alarm state detection, the time until the OAM cell generation stop from the fault recovery, and the like can be made as short as possible and the efficiency can be improved.

Furthermore, if the connection ID generator is provided with a processing frequency determiner for generating the connection ID by “n” cycles where “n” is a natural number and for outputting its cycle frequency signal, and the alarm state timer monitor and the OAM cell generator respectively time-share the alarm monitor processing and the OAM cell generation processing corresponding to the cycle frequency signal, the processings can be dispersed and the order of performing the processings can be set to an efficient order.

What we claim is:

1. An ATM communication monitoring device comprising:
a fundamental timer for producing a fundamental cycle signal;
a connection ID generator for generating connection ID's equal to or more than one within a section of the fundamental cycle signal; and
an OAM cell generator for queuing connection information of an OAM cell to be generated corresponding to the connection ID's at a predetermined cycle where the fundamental cycle signal is counted per each connection ID and for generating the OAM cell.

2. The ATM communication monitoring device as claimed in claim 1 wherein the OAM cell generator has a cell generation cycle memory for counting the fundamental cycle signal per each connection ID.

3. The ATM communication monitoring device as claimed in claim 2 wherein the connection ID generator further generates a monitoring control signal indicating that the connection ID is valid, and the cell generation cycle memory counts the fundamental cycle signal based on the monitoring control signal.

4. An ATM communication monitoring device comprising:
a fundamental timer for producing a fundamental cycle signal;
a connection ID generator for generating connection ID's equal to or more than one within a section of the fundamental cycle signal;
a counter for counting the fundamental cycle signal; and
an OAM cell generator for queuing connection information of an OAM cell to be generated corresponding to the connection ID's at a predetermined cycle based on a value of the counter and for generating the OAM cell.

5. The ATM communication monitoring device as claimed in claim 4 wherein timings for queuing the OAM cell are dispersed based on the counter value.

6. The ATM communication monitoring device as claimed in claim 1 or 4, further comprising an alarm state timer monitor for counting the fundamental cycle signal per each connection ID and for monitoring whether or not a monitor state of each connection ID is held for a predetermined time.

7. The ATM communication monitoring device as claimed in claim 6 wherein the alarm state timer monitor has an alarm state monitoring memory for counting the fundamental cycle signal per each connection ID.

8. The ATM communication monitoring device as claimed in claim 7 wherein the connection ID generator further generates a monitoring control signal indicating that the connection ID is valid, and the alarm state monitoring memory counts the fundamental cycle signal based on the monitoring control signal.

9. The ATM communication monitoring device as claimed in claim 1 or 4 wherein the OAM cell generator comprises a cell generation information queue portion for queuing the connection information, a cell assembler for assembling an OAM cell based on the queued connection information, and a cell inserter for determining whether or not a cell insertion is possible and for inserting the assembled OAM cell into an output cell flow.

10. The ATM communication monitoring device as claimed in claim 1 or 4 wherein the connection ID generator includes a counter for generating the connection ID for a plurality of lines.

11. The ATM communication monitoring device as claimed in claim 9 wherein the connection information comprises at least connection ID information, generated OAM cell classification information, and fault classification information, as well as line ID information for a plurality of lines.

12. The ATM communication monitoring device as claimed in claim 11 wherein the OAM cell classification information, the fault classification information, and the line ID information are coded.

13. The ATM communication monitoring device as claimed in claim 1 or 4, further comprising:
a counter for counting the fundamental cycle signal;
an alarm state monitoring memory for storing the counter value with a timer monitor start signal;
a subtracter for computing a difference between a present counter value and the stored counter value; and
a counter value determiner for comparing the difference with a predetermined monitored counter value and for determining whether or not a monitor state is held for a predetermined time.

14. The ATM communication monitoring device as claimed in claim 1 or 4, further comprising:
a counter for counting the fundamental cycle signal;
an adder for adding the counter value to a predetermined monitored counter value;
an alarm state monitoring memory for storing an arithmetic result of the adder with a timer monitor start signal; and
a counter value determiner for comparing the stored counter value with a present counter value and for determining whether or not a monitor state is held for a predetermined time.

15. The ATM communication monitoring device as claimed in claim 8 wherein the alarm state timer monitor includes a monitoring memory access controller for selecting by time-sharing an access to the alarm state monitoring memory based on a processing result from a processor of a receiving cell or an access to the alarm state monitoring memory by a timer monitor processing of the alarm state timer monitor.

16. The ATM communication monitoring device as claimed in claim 8, further comprising a schedule manager for managing, by time-sharing, timings for an alarm monitor processing in the alarm state timer monitor and for an OAM cell generation processing in the OAM cell generator.

17. The ATM communication monitoring device as claimed in claim 8 wherein the connection ID generator comprises a connection ID counter for counting a cell slot signal and a flag storage for outputting the monitoring control signal indicating a period when a counter value of the connection ID counter is valid.

18. The ATM communication monitoring device as claimed in claim 17 wherein the connection ID generator comprises a processing frequency determiner for generating the connection ID by “n” cycles where “n” is a natural number and for outputting its cycle frequency signal, and
the alarm state timer monitor and the OAM cell generator respectively time-share the alarm monitor processing and the OAM cell generation processing corresponding to the cycle frequency signal.
